(19) United States
(12) Patent Application Publication
(10) Pub. No.: US 2025/0309511 A1
(43) Pub. Date: Oct. 2, 2025

(54) BATTERY PACK

(71) Applicant: ZHEJIANG JINKO ENERGY STORAGE CO., LTD, Jiaxing (CN)

(72) Inventors: Yuanfu LV, Jiaxing (CN); Guochao CHEN, Jiaxing (CN); Yuanhang CHEN, Jiaxing (CN)

(21) Appl. No.: 18/932,530

(22) Filed: Oct. 30, 2024

(30) Foreign Application Priority Data
Mar. 27, 2024 (CN) 202410362473.X
Mar. 27, 2024 (CN) 202420613789.7
Apr. 7, 2024 (CN) 202410412419.1

(51) Int. Cl. H01M 50/682; A62C 3/16; H01M 50/209; H01M 50/298

(52) U.S. Cl. CPC H01M 50/682; A62C 3/16; H01M 50/209; H01M 50/298

(57) ABSTRACT

A battery pack, including a cell assembly and a CCS assembly. The cell assembly includes a plurality of cells, each of which is electrically connected through an electrical connector. The CCS assembly is located at a side of the cell assembly and is electrically connected to the electrical connector through a wire harness. The CCS assembly includes a first channel. A position where the first channel is positioned corresponds positions where explosion-proof valves of the plurality of cells are positioned, such that liquid is sprayed to the explosion-proof valves. The CCS assembly includes a wire harness separator, the wire harness separator includes a first accommodation groove, in which the wire harness and the electrical connector are received. When the cell undergoes thermal runaway and causes the explosion-proof valve to spray high-temperature heat flow, coolant in the first channel is sprayed to the position of the explosion-proof valve.

### CROSS-REFERENCE TO RELATED APPLICATIONS

The present application claims priority to Chinese Application No. 202420613789.7, which is filed on Mar. 27, 2024, Chinese Application No. 202410362473.X, which is filed on Mar. 27, 2024, and Chinese Application No. 202410412419.1, which is filed on Apr. 7, 2024, the contents of which are incorporated herein by reference in their entireties.

### TECHNICAL FIELD

The present disclosure relates to the technical field of batteries, and in particular to a battery pack.

### BACKGROUND

There is a risk of thermal runaway during use of a cell. Due to the thermal runaway, the heat generated by the cell may easily spread inside a cell assembly, to cause other normal cells to also undergo thermal runaway or even combustion and explosion. At present, a battery pack has insufficient protective measures against thermal runaway, resulting in low safety of the entire battery pack and easily affecting normal use of the battery pack.

### SUMMARY

In view of this, the present disclosure provides a battery pack to help solve the problem of low safety of the battery pack in the related art.

Some embodiments of the present disclosure provide a battery pack, including: a cell assembly, the cell assembly including a plurality of cells, and each of the plurality of cells being electrically connected through an electrical connector; and a cells contact system (CCS) assembly. The CCS assembly is located at a side of the cell assembly and is electrically connected to the electrical connector through a wire harness, the CCS assembly includes a first channel, and a position where the first channel is positioned corresponds to positions where explosion-proof valves of the cells are positioned, such that liquid is sprayed to the explosion-proof valves. The CCS assembly includes a wire harness separator, the wire harness separator includes a first accommodation groove, in which the wire harness and the electrical connector are received.

In some embodiments, the first channel includes a plurality of spray portions facing the plurality of cells; and the plurality of spray portions are positioned in one-to-one correspondence to the explosion-proof valves of the cells, and the first channel sprays the liquid correspondingly to the explosion-proof valves through the plurality of spray portions.

In some embodiments, the first channel includes a through-channel bottom wall; and the plurality of spray portions are located at the through-channel bottom wall, and a thickness of each of the plurality of spray portions is less than a thickness of the through-channel bottom wall.

In some embodiments, the first channel includes a through-channel bottom wall, and the plurality of spray portions are valve bodies arranged at the through-channel bottom wall.

In some embodiments, a reinforcing structure is provided between two adjacent spray portions of the plurality of spray portions.

In some embodiments, a second channel is provided between each of the plurality of spray portions and the explosion-proof valve corresponding thereto.

In some embodiments, the cell includes a top cover. The explosion-proof valve is arranged at the top cover, and the top cover includes a first protrusion portion extending towards the CCS assembly; and/or the CCS assembly includes a second protrusion portion extending towards the cell, and the first protrusion portion and/or the second protrusion portion defines the second channel.

In some embodiments, the CCS assembly includes a cover body, and the cover body is located at a side of the wire harness separator away from the cell assembly and is detachably connected to the wire harness separator.

In some embodiments, the first channel is arranged at the cover body, the wire harness separator is provided with a communication portion, and the communication portion, the spray portion, and the explosion-proof valve are positioned corresponding to one another.

In some embodiments, the first channel is arranged between the wire harness separator and the cover body.

In some embodiments, the cover body is provided with a second accommodation groove, the second accommodation groove is in communication with the first accommodation groove, and the wire harness and the electrical connector are received between the first accommodation groove and the second accommodation groove.

In some embodiments, the cover body and/or the wire harness separator is an injection molding member.

In some embodiments, the cover body and the wire harness separator enclose to define a first region and a second region, the first accommodation groove is arranged in the first region and the communication portion is arranged in the second region, and an isolation member is provided between the first region and the second region to isolate the first region from the second region.

In some embodiments, the isolation member is a sealing strip, the sealing strip is arranged around a circumference of the second region, and the isolation member includes an end abutting against the wire harness separator and another end abutting against the cover body.

In some embodiments, the isolation member is a baffle, the baffle is arranged around a circumference of the second region, and the baffle is integrally formed with the wire harness separator and abuts against the cover body.

In some embodiments, the wire harness separator includes a substrate and a third protrusion portion and a fourth protrusion portion that are connected to the substrate. The first accommodation groove includes a first recess and a second recess in communication with the first recess; the substrate, the third protrusion portion, and the fourth protrusion portion enclose to define the first recess; and the substrate and the fourth protrusion portion enclose to define the second recess. The wire harness is received in the first recess, and the electrical connector is received in the second recess.

In some embodiments, along a thickness direction of the wire harness separator, a cross section of the first recess is U-shaped or V-shaped.

In some embodiments, the third protrusion portion includes a first section and a second section and a third section that are respectively connected to two sides of the first section; and the first section extends along a width direction of the substrate, and the second section and the third section each extend along a length direction of the substrate.

In some embodiments, a plurality of third protrusion portions are arranged at intervals along a length direction of the wire harness separator, and a communication portion in communication with the explosion-proof valve of the cell is arranged between adjacent third protrusion portions of the plurality of third protrusion portions.

In some embodiments, the fourth protrusion portion includes a fourth section and a fifth section and a sixth section that are respectively connected to two sides of the fourth section; and the fourth section extends along a length direction of the substrate, and the fifth section and the sixth section each extend along a width direction of the substrate.

Some embodiments of the present disclosure provide a battery pack, including a cell assembly and a CCS assembly. The cell assembly includes a plurality of cells. The cells are electrically connected through an electrical connector. The CCS assembly is located at a side of the cell assembly and is electrically connected to the electrical connector through a wire harness. The CCS assembly includes a first channel. A position where the first channel is positioned corresponds to positions of explosion-proof valves of the cells, such that liquid is sprayed to the explosion-proof valves. The CCS assembly includes a wire harness separator, the wire harness separator has a first accommodation groove, in which the wire harness and the electrical connector are received. When the cell undergoes thermal runaway and causes the explosion-proof valve to spray high-temperature heat flow, coolant in the first channel is sprayed to the position of the explosion-proof valve, thereby achieving an effect of cooling down the cell and reducing a possibility of combustion and explosion due to continued rise in the temperature. At the same time, Due to the coolant, it is conducive to slowing down spread of heat, thereby reducing a possibility of thermal runaway in other normal cells and helping improve safety of the cell assembly and the entire battery pack.

It should be understood that the general description above and the detailed description in the following are merely exemplary, and cannot limit the present disclosure.

### BRIEF DESCRIPTION OF DRAWINGS

In order to better illustrate technical solutions in embodiments of the present disclosure, the accompanying drawings used in the embodiments are briefly introduced as follows. It should be noted that the drawings described as follows are merely part of the embodiments of the present disclosure, and other drawings can also be acquired by those skilled in the art without paying creative efforts.

FIG. 1 is an exploded view of a battery pack according to some embodiments of the present disclosure;

FIG. 2 is a schematic diagram of a cell assembly and a CCS assembly in FIG. 1;

FIG. 3 is a partial schematic diagram of connections among a wire harness separator, a wire harness, and an electrical connector in FIG. 2;

FIG. 4 is a partial cross-sectional view of a battery pack according to some embodiments of the present disclosure;

FIG. 5 is a schematic diagram of spray portions and a reinforcing structure according to some embodiments of the present disclosure;

FIG. 6 is a partial cross-sectional view of a battery pack according to some embodiments of the present disclosure;

FIG. 7 is a partial cross-sectional view of a battery pack according to some embodiments of the present disclosure;

FIG. 8 is a partial cross-sectional view of a battery pack according to some embodiments of the present disclosure;

FIG. 9 is a schematic diagram of a cover body according to some embodiments of the present disclosure;

FIG. 10 is a schematic diagram of distribution of a first region, a second region, and an isolation member in a CCS assembly according to some embodiments of the present disclosure;

FIG. 11 is a partial cross-sectional view of a battery pack according to some embodiments of the present disclosure;

FIG. 12 is a partial cross-sectional view of a battery pack according to some embodiments of the present disclosure;

FIG. 13 is a partial enlarged view of the wire harness separator in FIG. 2;

FIG. 14 is a schematic diagram of a wire harness separator according to some embodiments of the present disclosure;

FIG. 15 is a schematic diagram of a third protrusion portion according to some embodiments of the present disclosure;

FIG. 16 is a schematic diagram of a third protrusion portion according to some other embodiments of the present disclosure;

FIG. 17 is a schematic diagram of a fourth protrusion portion according to some embodiments of the present disclosure;

FIG. 18 is a schematic diagram of a fourth protrusion portion according to some other embodiments of the present disclosure;

FIG. 19 is a schematic diagram of a fourth protrusion portion according to some other embodiments of the present disclosure;

FIG. 20 is a schematic diagram of a fourth protrusion portion according to some other embodiments of the present disclosure;

FIG. 21 is a schematic diagram of a cell assembly and a CCS assembly according to some other embodiments of the present disclosure;

FIG. 22 is a schematic diagram of a wire harness separator according to some other embodiments of the present disclosure;

FIG. 23 is a schematic diagram of a wire harness separator according to some other embodiments of the present disclosure;

FIG. 24 is a schematic diagram of the wire harness separator in FIG. 23 from another perspective;

FIG. 25 is a schematic diagram of an electrical connector according to some embodiments of the present disclosure;

FIG. 26 is a schematic diagram of an electrical connector according to some other embodiments of the present disclosure;

FIG. 27 is a schematic diagram of a CCS assembly according to some embodiments of the present disclosure;

FIG. 28 is a partial schematic diagram of a blister structural member in a CCS assembly according to some embodiments of the present disclosure; and

FIG. 29 is a schematic diagram of an injection molding structural member in a CCS assembly according to some embodiments of the present disclosure.

### REFERENCE SIGNS

100: battery pack; 100a: upper housing; 100b: lower housing;
1: cell assembly; 11: cell; 111: explosion-proof valve; 112: top cover; 112a: first protrusion portion; 113: pole;
2: CCS assembly; 21: first channel; 21a: through-channel bottom wall; 211: spray portion; 212: reinforcing structure; 22: wire harness separator; 221: first accommodation groove; 221a: first recess; 221b: second recess; 221c: fitting hole; 222: communication portion; 223: substrate; 224: third protrusion portion; 2241: first section; 2241a: first end; 2241b: second end; 2242: second section; 2243: third section; 225: fourth protrusion portion; 225a: opening; 2251: fourth section; 2251a: third section; 2251b: fourth section; 2252: fifth section; 2253: sixth section; 226: connection pillar; 23: cover body; 231: second accommodation groove; 2a: first region; 2b: second region; 24: isolation member; 25: wire harness; 26: electrical connector; 261: electrical connection portion; 262: connection hole; 27: second protrusion portion; 28: injection molding structural member; 281: first main body; 2811: first plate body; 2811a: first through-hole; 2811b: first mounting hole; 2811c: second through-hole; 28111: left end portion; 28112: right end portion; 28113: inner side wall; 28114: top surface; 2812: second plate body; 282: clamping portion; 283: reinforcing portion; 284: connecting structure; 285: third through-hole; 29: blister structural member; 291: protrusion structure; 2911: outer side wall; 29111: limiting portion; 292: second main body; 2921: accommodation space; 2921a: first accommodation portion; 2921b: second accommodation portion; 293: first limiting pillar; 3: second channel.

### DESCRIPTION OF EMBODIMENTS

In order to better illustrate the technical solutions of the present disclosure, the embodiments of the present disclosure will be described in detail below with reference to the accompanying drawings.

It should be clear that the described embodiments are only some of, rather than all of the embodiments of the present disclosure. All other embodiments obtained by those of ordinary skill in the art without creative efforts based on the embodiments of the present disclosure shall fall within a protection scope of the present disclosure.

The terms used in the embodiments of the present disclosure are intended only to describe particular embodiments and are not intended to limit the present disclosure. As used in the embodiments of the present disclosure and the appended claims, the singular forms of “a/an”, “one”, and “the” are also intended to include plural forms, unless otherwise clearly specified in the context.

It should be understood that the term “and/or” used herein is merely an association relationship describing associated objects, indicating that there may be three relationships, for example, A and/or B may indicate that three cases, i.e., A existing individually, A and B existing simultaneously, B existing individually. In addition, the character “/” herein generally indicates that the related objects before and after the character form an “or” relationship.

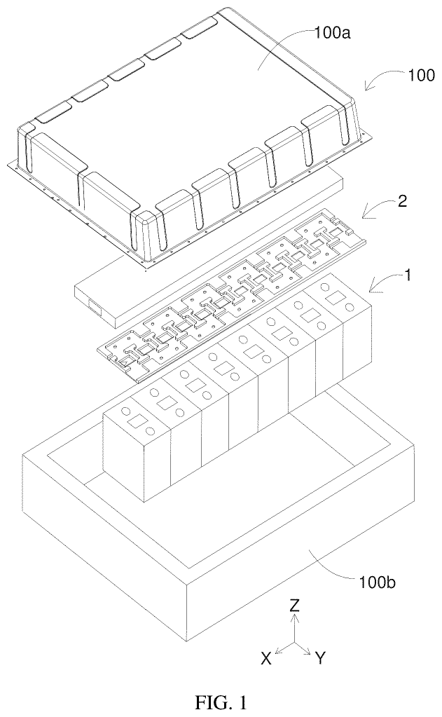

As shown in FIG. 1 to FIG. 3, some embodiments of the present disclosure provide a battery pack 100, including a cell assembly 1 and a cells contact system (CCS) assembly 2. The cell assembly 1 includes a plurality of cells 11. The cells 11 are electrically connected through an electrical connector 26. The CCS assembly 2 is located at one side of the cell assembly 1 and is electrically connected to the electrical connector 26 through a wire harness 25. The CCS assembly 2 includes a first channel 21, and a position where the first channel 21 is positioned corresponds to a position where the explosion-proof valve 111 of the cell 11 is positioned, so as to spray liquid to the explosion-proof valve 111. The CCS assembly 2 includes a wire harness separator 22, the wire harness separator 22 includes a first accommodation groove 221, and the wire harness 25 and the electrical connector 26 are received in the first accommodation groove 221.

The battery pack 100 includes an upper housing 100a and a lower housing 100b. The upper housing 100a covers the lower housing 100b. The upper housing 100a and the lower housing 100b enclose to define an accommodation space, in which the cell assembly 1 and the CCS assembly 2 are received. One cell assembly 1 or a plurality of cell assemblies 1 may be provided, and the plurality of cell assemblies 1 may be electrically connected in series and/or in parallel. The cell assembly 1 includes a plurality of cells 11, and the plurality of cells 11 may be electrically connected in series and/or in parallel.

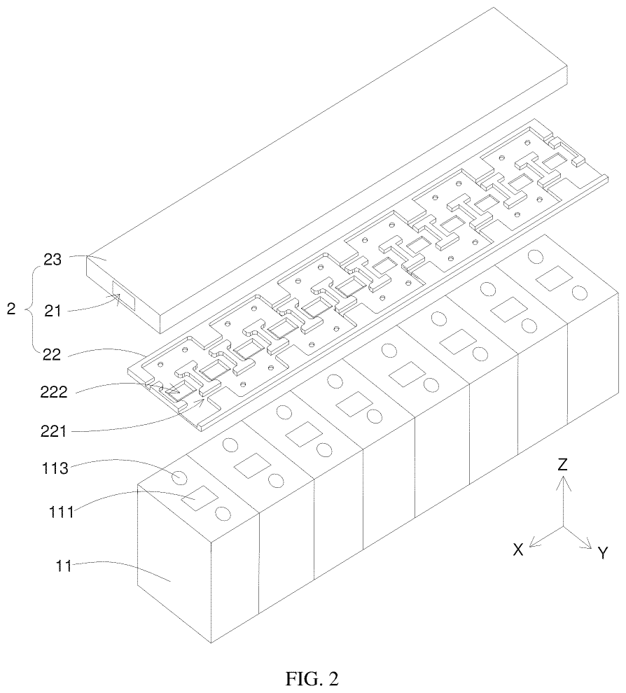

As shown in FIG. 1, in some embodiments, the cell assembly 1 may include a single row of cells 11. As shown in FIG. 2, the cell 11 is provided with an explosion-proof valve 111. After a temperature of the cell 11 exceeds a normal value, an internal pressure thereof may increase rapidly. In this case, the cell 11 releases the internal pressure thereof to the outside through the explosion-proof valve 111 to reduce a possibility of explosion of the cell 11.

The CCS assembly 2 is configured to monitor a voltage and/or a temperature of the cell assembly 1 and can transmit a collected signal to a battery management system (not shown), to achieve over-current protection and/or thermal runaway management of the cell assembly 1. The CCS assembly 2 is located at a side of the cell assembly 1 close to the upper housing 100a, and the CCS assembly 2 may be fixedly connected to the cell assembly 1. The number of the CCS assembly/assemblies 2 may correspond to that of the cell assembly/assemblies 1. The CCS assembly 2 includes a first channel 21, and a position where the first channel 21 is positioned corresponds to a position where the explosion-proof valve 111 of the cell 11 is positioned, that is, along a height direction Z of the battery pack 100, a projection of the explosion-proof valve 111 of each cell 11 is located within a projection of the first channel 21. The first channel 21 is filled with coolant. When the temperature of the cell 11 exceeds a normal value, the cell 11 begins to release pressure to the outside through the explosion-proof valve 111 and, at the same time, sprays out high-temperature heat flow. In this case, the coolant from the first channel 21 is sprayed to the explosion-proof valve 111 of the cell 11 to cool down the cell 11, thereby reducing a possibility of thermal runaway of the entire cell assembly 1 due to heat diffusion and thus reducing a risk of combustion and explosion of the cell assembly 1, which helps improve safety of the battery pack 100.

The number of the first channel/channels 21 may correspond to the number of row/rows of the cells 11. For example, when the cell assembly 1 includes a single row of cells 11, the CCS assembly 2 may include one first channel 21 corresponding to the single row of cells 11.

Currently, after thermal runaway occurs in a cell of the cell assembly, the explosion-proof valve of this cell may release high-temperature heat flow to the outside, and the heat from the high-temperature heat flow may be transferred to other cell(s). For example, the high-temperature heat flow may directly sputter to other cell(s), resulting in a rapid temperature rise of other cell(s) to cause thermal runaway. That is, the heat generated by the cell undergoing thermal runaway spreads and diffuses inside the cell assembly, to trigger a chain reaction of thermal runaway, thereby bringing safety hazards to the battery pack, resulting in a risk of combustion and explosion of the battery pack, and thus affecting safety performance and the service life of the battery pack.

Based on the above problems, in some embodiments of the present disclosure, the CCS assembly 2 is provided with a first channel 21 configured to spray coolant. When the cell 11 undergoes thermal runaway and causes the explosion-proof valve 111 to spray high-temperature heat flow, the coolant in the first channel 21 is sprayed to the position of the explosion-proof valve 111, thereby achieving an effect of cooling down the cell 11 and reducing a possibility of combustion and explosion due to continued rise in the temperature. At the same time, under the action of the coolant, it is also conducive to slowing down spread of heat, thereby reducing a possibility of thermal runaway in other normal cells 11 and thus helping improve safety of the cell assembly 1 and the entire battery pack 100. On the other hand, in some embodiments of the present disclosure, a spray function is integrated into the CCS assembly 2, so that there is no need to additionally arrange a spray mechanism inside the battery pack 100, thereby helping save internal space of the battery pack 100, and there is space inside the battery pack 100 to add the cell 11, which helps arrange as many cells 11 as possible inside the battery pack 100 to improve energy density of the battery pack 100, and then helps improve overall reliability of the battery pack 100. At the same time, due to a short distance between the CCS assembly 2 and the cell assembly 1, the spray function of the CCS assembly 2 can respond immediately after thermal runaway occurs in the cell 11, thereby helping speed up cooling of the cell 11 and further helping improve the safety of the battery pack 100. In addition, no spray mechanism being additionally arranged helps reduce a weight of the battery pack 100, thereby realizing a lightweight design of the battery pack 100 and simplifying an internal structure of the battery pack 100, and thus helping improve the assembly efficiency of the battery pack 100.

The first channel 21 is connected to a liquid supply mechanism (not shown). The liquid supply mechanism includes a liquid supply tank and a pump body. Coolant is stored in the liquid supply tank. The pump body pumps the coolant in the liquid supply tank into the first channel 21 to spray the coolant to the explosion-proof valve 111. The liquid supply mechanism may be arranged outside the battery pack 100, to help save space inside the battery pack 100.

The coolant may be pure water, ethylene glycol, fluorinated liquid, or perfluorohexanone, and also may be other liquid that can achieve an effect of cooling.

The CCS assembly 2 includes a wire harness 25, an electrical connector 26, and a wire harness separator 22. The wire harness 25 and the electrical connector 26 are received in the first accommodation groove 221 of the wire harness separator 22. The electrical connector 26 may be welded to the cell 11 to achieve an electrical connection to the cell 11. The wire harness 25 may be welded to the electrical connector 26 to achieve an electrical connection to the electrical connector 26, so as to facilitate acquisition of various data of the cell 11. For example, the electrical connector 26 may be an aluminum bar or a copper bar. The wire harness 25 may be a copper wire, an aluminum alloy wire, a flexible printed circuit (FPC), or a printed circuit board (PCB).

The first accommodation groove 221 may be recessed towards the cell assembly 1 along a thickness direction Z of the battery pack 100. For the wire harness 25, the wire harness 25 may be routed in the first accommodation groove 221, and the first accommodation groove 221 has an effect of limiting and fixing the wire harness 25. For example, the wire harness 25 may be clamped to the first accommodation groove 221, thereby reducing a possibility that the wire harness 25 may slide and shift on the wire harness separator 22 or even fall off from the wire harness separator 22 to ensure stability of connection of the wire harness 25, and thus helping improve reliability of the CSS assembly 2. In the related art, the wire harness and the wire harness separator are generally connected by a cable tie, and the cable tie is easy to interfere with the cell when fixing the wire harness to scratch a blue film on a surface of the cell, which brings certain safety hazards to the cell and reduces reliability of the battery pack. Compared with the related art, in some embodiments of the present disclosure, the first accommodation groove 221 is arranged to fix the wire harness 25, thereby improving stability of the wire harness 25 and also reducing a possibility of scratching the blue film of the cell 11, thus helping prolong the service life of the cell 11 and improving reliability of the battery pack 100. In addition, since there is no need to fix the wire harness 25 by using a cable tie according to the embodiments of the present disclosure, it is conducive to saving space of the CCS assembly 2 and facilitating arrangement of the CCS assembly 2 and the cell assembly 1 in the battery pack 100. For the electrical connector 26, the first accommodation groove 221 provides a mounting space for the electrical connector 26 and provides a positioning effect for assembly of the electrical connector 26, thereby helping improve efficiency of assembly of the electrical connector 26 and the wire harness separator 22. At the same time, the first accommodation groove 221 also achieves an effect of limiting the electrical connector 26 to improve stability of assembly of the electrical connector 26 on the wire harness separator 22, thus helping improve stability of connection between the electrical connector 26, the cell 11 and the wire harness 25.

In some embodiments, the electrical connector 26 and the wire harness 25 are connected by, but not limited to, ultrasonic welding, laser welding, resistance welding, gas welding, and friction welding.

In some embodiments, the electrical connector 26 and the cell 11 are connected by, but not limited to, ultrasonic welding, laser welding, hot pressure welding, solder welding, and induction welding.

As shown in FIG. 2 and FIG. 4, in some embodiments, the first channel 21 has a plurality of spray portions 211 facing the cell 11, the spray portions 211 are positioned in one-to-one correspondence to the explosion-proof valves 111 of the cells 11, and the first channel 21 sprays liquid to the corresponding explosion-proof valves 111 through the spray portions 211.

When the cell assembly 1 is in a normal state, that is, when no cell 11 undergoes thermal runaway, the spray portion 211 of the first channel 21 is in a closed state. In this case, the coolant is received in the first channel 21 and does not leak out through the spray portion 211. When the cell 11 undergoes thermal runaway and causes the explosion-proof valve 111 to release high-temperature heat flow to the outside, since a position where the spray portion 211 is positioned corresponding to a position where the explosion-proof valve 111 is positioned, the high-temperature heat flow breaks through the spray portion 211 to form an opening for the coolant to flow out, that is, the spray portion 211 is opened under the impact of the high-temperature heat flow, so that the coolant in the first channel 21 is sprayed through the spray portion 211 to the corresponding explosion-proof valve 111, thereby cooling down the cell 11.

Through the arrangement of the spray portion 211, when the cell 11 undergoes thermal runaway, the CCS assembly 2 can immediately inject coolant to the explosion-proof valve 111 to reduce a possibility of fire and explosion due to a further increase in the temperature of the cell 11, thereby helping improve the safety of the battery pack 100. At the same time, the spray portion 211 is opened under the impact of the high-temperature heat flow, without a needing for manual or other procedures for operation control, thereby helping achieve rapid spraying and reduce the cost of the battery pack 100.

As shown in FIG. 4, in some embodiments, the first channel 21 includes a through-channel bottom wall 21a, the spray portion 211 is positioned at the through-channel bottom wall 21a, and a thickness of the spray portion 211 is less than that of the through-channel bottom wall 21a.

The through-channel bottom wall 21a is located at an end of the first channel 21 close to the cell 11. Along a width direction Y of the battery pack 100, a cross section of the spray portion 211 may be in a shape of a circle or a rectangle, or in other shape. The thickness of the spray portion 211 is less than that of the through-channel bottom wall 21a, that is, the spray portion 211 is a relatively weak part of the structure on the through-channel bottom wall 21a, so that the spray portion 211 can be easily broken through under an external force, i.e., it is convenient for the high-temperature heat flow ejected by the explosion-proof valve 111 to quickly break through the spray portion 211, so that the coolant is sprayed to the explosion-proof valve 111 through the spray portion 211, thereby helping cool down the cell 11 undergoing thermal runaway, to improve the safety of the battery pack 100.

In some embodiments, the spray portion 211 may be formed on the through-channel bottom wall 21a by stamping, laser etching, or the like, which is not limited in the embodiments of the present disclosure.

In some other embodiments, the spray portion 211 is made of a material different from that of the through-channel bottom wall 21a, and the spray portion 211 may be mounted on the through-channel bottom wall 21a by welding, bonding, or snapping. For example, the through-channel bottom wall 21a may be made of a plastic material, and the spray portion 211 may be made of a mica material. The spray portion 211 may be a mica thin plate embedded into the through-channel bottom wall 21a. Mica has good thermal insulation properties, thereby achieving an effect of thermal insulation between the first channel 21 and the cell assembly 1, which helps reduce a possibility of a chemical reaction or physical reaction of the coolant inside the first channel 21 due to an influence of the temperature of the cell assembly 1, to ensure stability of the coolant, thereby helping improve stability of the spray function of the CSS assembly 2.

In some embodiments, the first channel 21 includes a through-channel bottom wall 21a, and the spray portion 211 is a valve body arranged at the through-channel bottom wall 21a.

When the cell assembly 1 is in a normal state, the valve body is closed, and the coolant is received in the first channel 21. When the explosion-proof valve 111 sprays out high-temperature heat flow, the valve body is opened to cause the coolant to be sprayed to the explosion-proof valve 111. The valve body may be electrically connected to a controller (not shown) to control opening and closing of the valve body; or the valve body may be opened automatically under a high-temperature fluid. Through the arrangement of the valve body, it is conducive to controlling start and stop of the spraying of the CCS assembly 2, thereby helping improve the reliability of the spraying function of the CCS assembly 2.

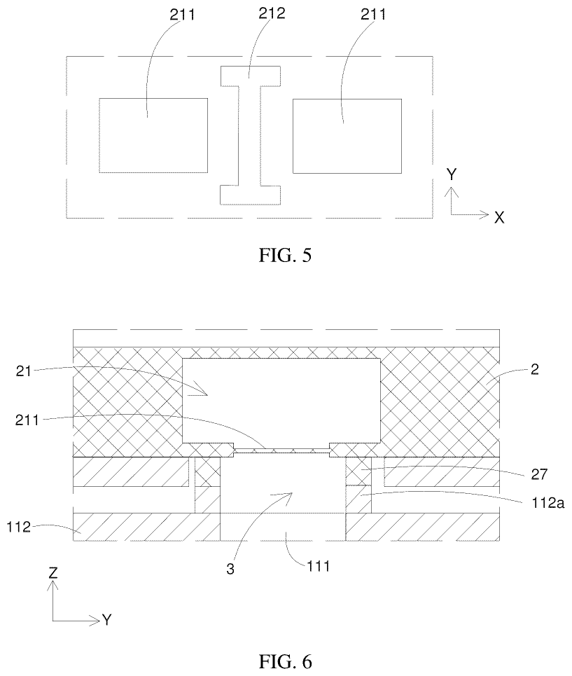

As shown in FIG. 5, in some embodiments, a reinforcing structure 212 is arranged between any two adjacent spray portions 211.

The reinforcing structure 212 may be positioned at an inner surface of the first channel 21 and may protrude from the inner surface of the first channel 21. Or, the reinforcing structure 212 may be positioned at an outer surface of the first channel 21 and may protrude from the outer surface of the first channel 21. The reinforcing structure 212 may be in a shape of a straight line, a shape of I, or a shape of a star. When the high-temperature heat flow impacts the spray portion 211 or the coolant is sprayed to the outside through the spray portion 211, a region where the spray portion 211 is positioned and surrounding regions thereof may be subjected to an external force, resulting in a risk of deformation or even cracking in the above-mentioned regions. Through the arrangement of the reinforcing structure 212, it is conducive to improving structural strength of the region where the spray portion 211 is positioned and the surrounding regions thereof, thereby helping improve stability of the overall structure of the first channel 21, to facilitate the CCS assembly 2 to spray the coolant to the cell 11 undergoing thermal runaway.

As shown in FIG. 6, in some embodiments, a second channel 3 is arranged between the spray portion 211 and the explosion-proof valve 111 corresponding thereto.

The high-temperature heat flow released from the explosion-proof valve 111 impacts the spray portion 211 through the second channel 3. The second channel 3 achieves an effect of guiding the high-temperature heat flow, so that the high-temperature heat flow can impact the spray portion 211 in a more concentrated manner, that is, it is conducive to improving the force of the high-temperature heat flow, making it easier to break through the spray portion 211, so as to facilitate the spraying of the coolant. At the same time, the second channel 3 also achieves an effect of blocking the high-temperature heat flow, reducing a possibility of sputtering of the high-temperature heat flow ejected from one cell 11 to other cell(s) 11, thereby ensuring the safety of the other cell(s) 11.

On the other hand, the coolant is sprayed to the corresponding explosion-proof valve 111 through the second channel 3. The second channel 3 also achieves an effect of guiding the coolant, so that the coolant is more accurately sprayed to the corresponding explosion-proof valve 111, so as to cool down the cell 11 undergoing thermal runaway and prevent a further increase in the temperature of the cell 11. At the same time, the second channel 3 also achieves an effect of cooling the coolant, reducing a possibility of an influence on normal operation of other components in the CCS assembly 2 due to spraying of the coolant to the outside of the cell 11, so as to facilitate the normal and stable operation of the CCS assembly 2.

As shown in FIG. 6, in some embodiments, the cell 11 is provided with a top cover 112, the explosion-proof valve 111 is arranged at the top cover 112, and the top cover 112 includes a first protrusion portion 112a extending towards the CCS assembly 2; and/or the CCS assembly 2 includes a second protrusion portion 27 extending towards the cell 11, and the first protrusion portion 112a and/or the second protrusion portion 27 defines the second channel 3.

The first protrusion portion 112a may extend along the height direction Z of the battery pack 100. The first protrusion portion 112a may be integrally formed with the top cover 112, or the first protrusion portion 112a may be mounted onto the top cover 112. When the second channel 3 is defined by the first protrusion portion 112a, the first protrusion portion 112a may abut against the CCS assembly 2, or may have a certain distance from the CCS assembly 2.

The second protrusion portion 27 may extend along the height direction Z of the battery pack 100. The second protrusion portion 27 may be integrally formed with the CCS assembly 2, or the second protrusion portion 27 may be mounted onto the CCS assembly 2. When the second channel 3 is defined by the second protrusion portion 27, the second protrusion portion 27 may abut against the top cover 112 of the cell 11, or may have a certain distance from the top cover 112 of the cell 11.

When the second channel 3 is defined by both the first protrusion portion 112a and the second protrusion portion 27, the first protrusion portion 112a may abut against the second protrusion portion 27, or there is a certain distance between the first protrusion portion 112a and the second protrusion portion 27.

The above-mentioned design helps simplify the structure of the second channel 3, thereby helping achieve arrangement and layout of the second channel 3 on the CCS assembly 2, so that the second channel 3 can play a reliable guiding role between the cell 11 and the CCS assembly 2 to ensure the normal and stable operation of both the CCS assembly 2 and the cell assembly 1.

As shown in FIG. 2, in some embodiments, the CCS assembly 2 includes a cover body 23, and the cover body 23 is located at a side of the wire harness separator 22 away from the cell assembly 1 and is detachably connected to the wire harness separator 22.

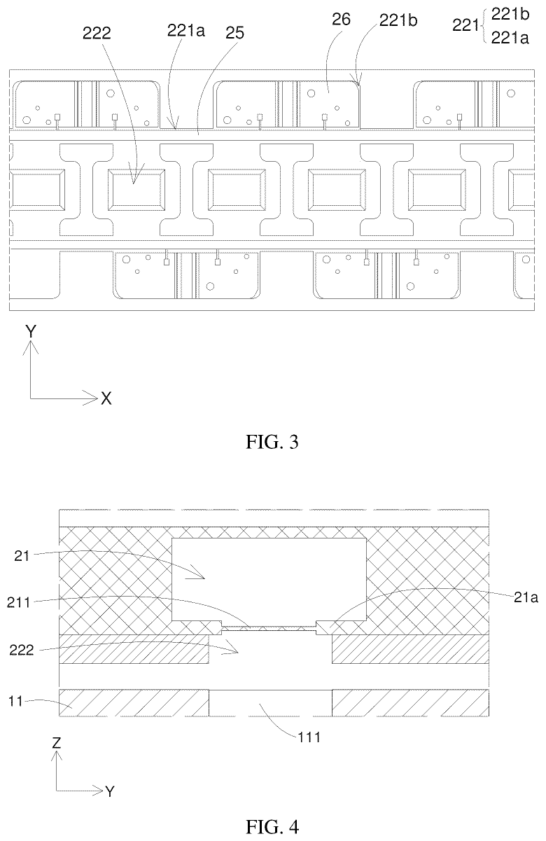

Referring to FIG. 3 together, during the assembly of the CCS assembly 2, the electrical connector 26 and the wire harness 25 may be mounted to the wire harness separator 22 first, and then the cover body 23 covers the wire harness separator 22. The cover body 23 achieves an effect of limiting the electrical connector 26 and the wire harness 25 arranged at the wire harness separator 22, thereby reducing a possibility of falling off of the electrical connector 26 and the wire harness 25, and thus improving assembly stability thereof. At the same time, the cover body 23 further achieves an effect of protecting the electrical connector 26, the wire harness 25, and the wire harness separator 22, thereby reducing a possibility of damage caused by collision of the electrical connector 26, the wire harness 25, and the wire harness separator 22 with the outside during the assembly of the battery pack 100 and also reducing a possibility of falling of dust or other stains on the wire harness separator 22, and thus helping prolong the service life of the entire CCS assembly 2. When the wire harness separator 22 or the cover body 23 needs to be repaired or replaced, the cover body 23 is only required to be detached from the wire harness separator 22.

In some embodiments, the cover body 23 is engaged with the wire harness separator 22. For example, the cover body 23 includes a mounting protrusion (not shown) extending towards the wire harness separator 22, the wire harness separator 22 includes a mounting groove (not shown) recessed towards the cell assembly 1, and the mounting protrusion extends into the mounting groove and is engaged with the mounting groove to realize mounting between the cover body 23 and the wire harness separator 22. During disassembly, there is only a need to disengage the mounting protrusion from the mounting groove under an external force, thereby facilitating maintenance and replacement of the cover body 23 or the wire harness separator 22, to help prolong the service life of the CCS assembly 2. A plurality of mounting protrusions and a plurality of mounting grooves may be provided, to improve stability of the connection between the cover body 23 and the wire harness separator 22.

In some other embodiments, the cover body 23 is detachably connected to the wire harness separator 22 by a fastener (not shown) such as a screw.

As shown in FIG. 2 to FIG. 4, in some embodiments, the first channel 21 is arranged at the cover body 23, the wire harness separator 22 is provided with a communication portion 222, and the communication portion 222, the spray portion 211, and the explosion-proof valve 111 are positioned corresponding to one another.

The communication portions 222 arranged at the wire harness separator 22 are in one-to-one correspondence to the explosion-proof valves 111 of the cells 11. The explosion-proof valve 111 of the cell 11 is sprayed to the spray portion 211 through the communication portion 222. Correspondingly, the coolant sprayed from the spray portion 211 is sprayed to the explosion-proof valve 111 through the communication portion 222. Through the arrangement of the communication portion 222, a channel for the high-temperature heat flow and the coolant to circulate is formed between the cover body 23 and the cell assembly 1, that is, the high-temperature heat flow is sprayed to the spray portion 211 through the communication portion 222 and the coolant is sprayed to the explosion-proof valve 111 through the communication portion 222, thereby reducing a possibility of blocking of the coolant and high-temperature heat flow by the wire harness separator 22, to facilitate the coolant to cool down the cell 11 undergoing thermal runaway, thereby improving the safety of the entire battery pack 100.

As shown in FIG. 2 to FIG. 4, in some embodiments, the communication portion 222 is a through-hole provided in the wire harness separator 22. A size of the through-hole is the same as that of the explosion-proof valve 111 of the cell 11 or slightly larger than that of the explosion-proof valve 111, to facilitate passage of the coolant and increase an action area of the coolant, thereby improving the cooling efficiency of the coolant.

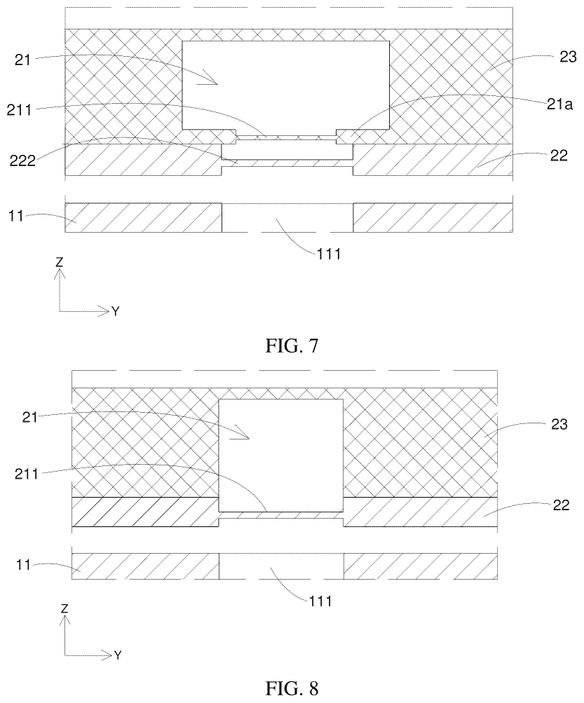

As shown in FIG. 7, in some other embodiments, the communication portion 222 is a weak structure disposed at a bottom wall of the wire harness separator 22. That is, a thickness of the communication portion 222 is less than that of the bottom wall of the wire harness separator 22. For example, the communication portion 222 may be formed at the bottom wall of the wire harness separator 22 in a machining manner such as stamping and laser etching. The high-temperature heat flow sprayed from the explosion-proof valve 111 can break through the communication portion 222 and spray towards the spray portion 211.

As shown in FIG. 8, in some embodiments, the first channel 21 is arranged between the wire harness separator 22 and the cover body 23.

The cover body 23 and the wire harness separator 22 may enclose to define the first channel 21. That is, the cover body 23 may serve as a top wall of the first channel 21 and/or a side wall of the first channel 21, and the wire harness separator 22 may serve as a top wall of the first channel 21 and/or a side wall of the first channel 21. Such a design helps save the space of the cover body 23, that is, helps make the cover body 23 thinner, thereby realizing the spray function of the CCS assembly 2 while helping achieve a lightweight and thin design of the CCS assembly 2.

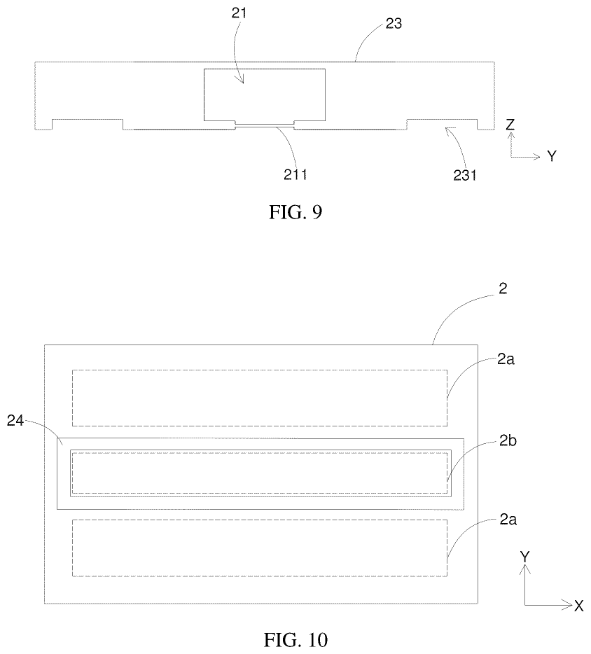

As shown in FIG. 2, FIG. 3, and FIG. 9, in some embodiments, the cover body 23 is provided with a second accommodation groove 231, the second accommodation groove 231 is in communication with the first accommodation groove 221, and the wire harness 25 and the electrical connector 26 are received between the first accommodation groove 221 and the second accommodation groove 231.

The second accommodation groove 231 extends in a direction away from the wire harness separator 22. The second accommodation groove 231 is arranged corresponding to the first accommodation groove 221 and is in communication with the first accommodation groove 221, to enclose to define a cavity, and the wire harness 25 and the electrical connector 26 are received in the cavity. Through the arrangement of the second accommodation groove 231, the cover body 23 provides a receiving space for the wire harness 25 and the electrical connector 26, which facilitates realization of a lightweight and thin design of the cover body 23 and the wire harness separator 22 and also facilitates reduction of the overall weight of the CCS assembly 2. At the same time, this design also reduces a possibility of interference of the cover body 23 with the electrical connector 26 or the wire harness 25, to help improve stability and reliability of the connection between the cover body 23 and the wire harness separator 22 and reduce a possibility of collision of and damage to the electrical connector 26 or the wire harness 25, thereby helping prolong the service life of the CCS assembly 2.

In some embodiments, the cover body 23 and/or the wire harness separator 22 are/is injection molding members/an injection molding member.

Both the cover body 23 and the wire harness separator 22 may be made of plastic materials. Both the cover body 23 and the wire harness separator 22 may be injection molded, thereby helping reduce machining difficulty of the cover body 23 and the wire harness separator 22, improving overall machining efficiency of the CCS assembly 2, and also helping save the manufacturing cost of the CCS assembly 2.

In some other embodiments, the cover body 23 and/or the wire harness separator 22 may be machined by extrusion molding, press molding, or blow molding.

As shown in FIG. 2, FIG. 3, and FIG. 10, in some embodiments, the cover body 23 and the wire harness separator 22 enclose to define a first region 2a and a second region 2b, the first accommodation groove 221 is arranged in the first region 2a, the communication portion 222 is arranged in the second region 2b, and an isolation member 24 is arranged between the first region 2a and the second region 2b to isolate the first region 2a from the second region 2b.

The wire harness 25 and the electrical connector 26 are located in the first region 2a. The spray portion 211 of the first channel 21 and the explosion-proof valve 111 of the cell 11 are located in the second region 2b. In other words, the first region 2a is a region where the CCS assembly 2 is electrically connected; and the wire harness 25, the electrical connector 26, and the cell 11 are electrically connected in the first region 2a. The second region 2b is a region where the spray function of the CCS assembly 2 is realized; and the coolant is sprayed to the explosion-proof valve 111 through the spray portion 211 and the communication portion 222 in the second region 2b, to achieve an effect of cooling down the cell 11. The isolation member 24 achieves an effect of isolation and protection between an operation region (i.e., the second region 2b) and a non-operation region (i.e., the first region 2a) of the coolant, to reduce a possibility of falling of the sprayed coolant into the first region 2a, thereby reducing a possibility of failure of the electrical connection failure or even fire and explosion in the first region 2a, helping improve stability of the electrical connection inside the CCS assembly 2, and improving safety of the CCS assembly 2.

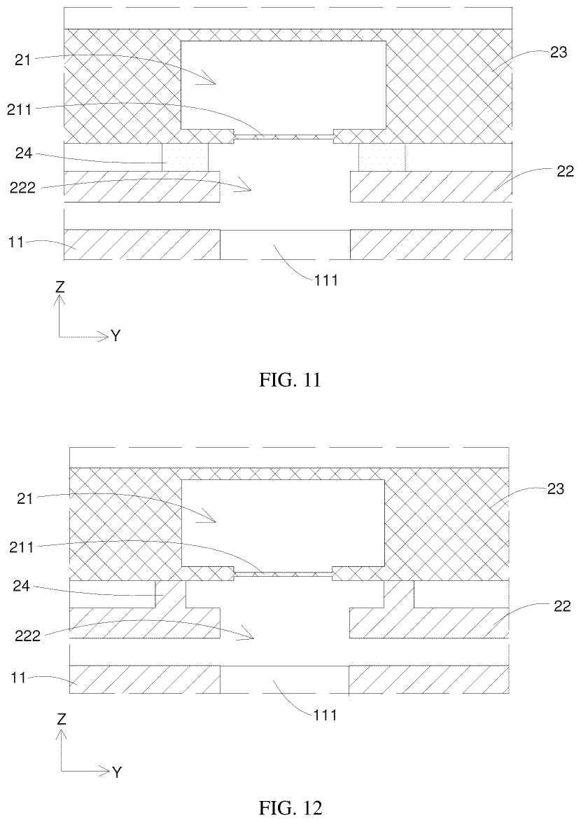

As shown in FIG. 10 and FIG. 11, in some embodiments, the isolation member 24 is a sealing strip, the sealing strip is arranged around a circumference of the second region 2b, and the isolation member 24 includes an end abutting against the wire harness separator 22 and another end abutting against the cover body 23.

Referring to FIG. 2 together, the following description is based on an example in which the cell assembly 1 has a single row of cells 11. The first channel 21 is arranged at the cover body 23, and the communication portion 222 is provided at a middle region of the wire harness separator 22. Along the width direction Y of the battery pack 100, two ends of the communication portion 222 are each provided with the first accommodation groove 221, and the corresponding wire harness 25 and the electrical connector 26 are mounted in each first accommodation groove 221, to realize the electrical connection between the cell assembly 1 and the CCS assembly 2. That is, in the CCS assembly 2, the first region 2a is located at two sides of the second region 2b.

The sealing strip may be made of silicone, rubber, or a material with better sealing performance, which is not limited in the embodiments of the present disclosure. The sealing strip is arranged around the circumference of the second region 2b. Along the height direction Z of the battery pack 100, a top surface of the sealing strip abuts against the cover body 23, and a bottom surface of the sealing strip abuts against the wire harness separator 22. The sealing strip achieves an effect of isolation between the first region 2a and the second region 2b. That is, the second region 2b is enclosed by the sealing strip to reduce a possibility of spraying of the coolant into the first region 2a, so as to achieve normal and stable operation of the CCS assembly and improve the safety of the battery pack 100.

As shown in FIG. 10 and FIG. 12, the isolation member 24 is a baffle, the baffle is arranged around a circumference of the second region 2b, and the baffle is integrally formed with the wire harness separator 22 and abuts against the cover body 23.

The baffle may extend along the thickness direction Z of the battery pack 100 and abuts against the cover body 23, to achieve an effect of isolation between the first region 2a and the second region 2b, thereby reducing a possibility of spraying of the coolant into the first region 2a, so as to achieve normal and stable operation of the CCS assembly 2. The baffle is integrally formed with the wire harness separator 22, so that there is no need to additionally mount other isolation members 24 in the CCS assembly 2. That is, after the cover body 23 and the wire harness separator 22 are assembled, the first region 2a and the second region 2b can be isolated from each other, thereby helping simplify an internal structure of the CCS assembly 2 and improving assembly efficiency of the CCS assembly 2.

In the above embodiments, the isolation member 24 may be provided with a mica sheet, a ceramic sheet, or other materials with good high-temperature resistance, thermal insulation, and insulation properties, thereby facilitating the isolation member 24 to achieve electrical isolation and heat isolation between the first region 2a and the second region 2b and helping improve the safety of the CCS assembly 2.

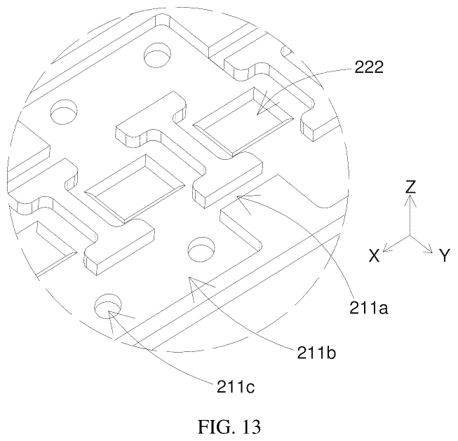

As shown in FIG. 3 and FIG. 13, in some embodiments, the first accommodation groove 221 includes a first recess 221a and a second recess 221b in communication with the first recess 221a, the wire harness 25 is received in the first recess 221a, the electrical connector 26 is received in the second recess 221b; and along a thickness direction of the wire harness separator 22, a cross section of the first recess 221a is U-shaped or V-shaped.

Both the first recess 221a and the second recess 221b may each extend along the height direction Z of the battery pack 100. The first recess 221a achieves an effect of limiting the wire harness 25. A width of the first recess 221a gradually decreases from an opening to the bottom. That is, the first recess 221a may have an inclined side wall, so that a cross section of the first recess 221a is approximately “V”-shaped. A bottom wall of the first recess 221a may be arc-shaped. That is, the cross section of the first recess 221a is approximately U-shaped. This design guides the mounting of the wire harness 25, to improve assembly efficiency between the wire harness 25 and the wire harness separator 22. At the same time, the width of the first recess 221a changes, thereby facilitating engagement of the wire harness 25 with the first recess 221a, so as to limit and fix the wire harness 25, thus reducing a possibility of falling off of the wire harness 25 from the wire harness separator 22.

The second recess 221b is in communication with the first recess 221a, and the second recess 221b is provided with a fitting hole 221c. Referring to FIG. 2 together, the electrical connector 26 may be connected to a pole 113 of the cell 11 through the fitting hole 221c.

Through the arrangement of the first recess 221a and the second recess 221b, the wire harness 25 and the electrical connector 26 can have corresponding mounting regions, thereby helping improve stability of the arrangement of the wire harness 25 and the electrical connector 26 at the wire harness separator 22. At the same time, the first recess 221a and the second recess 221b achieve an effect of positioning the wire harness 25 and the electrical connector 26 respectively, thereby helping improve assembly efficiency of the wire harness separator 22.

As shown in FIG. 3 and FIG. 13, in some embodiments, the first recesses 221a are continuously arranged along a length direction X of the wire harness separator 22; or the first recesses 221a are arranged at intervals along the length direction X of the wire harness separator 22.

The first recesses 221a may be continuously arranged, thereby facilitating the mounting of the wire harness 25, so as to improve assembly efficiency of the CCS assembly 2. At the same time, it is further conducive to simplifying the structure of the wire harness separator 22 and facilitating machining of the wire harness separator 22.

The first recesses 221a may be arranged at intervals. This design helps save materials required to manufacture the wire harness separator 22, thereby helping reduce a weight of the wire harness separator 22 and reducing the manufacturing cost of the wire harness separator 22.

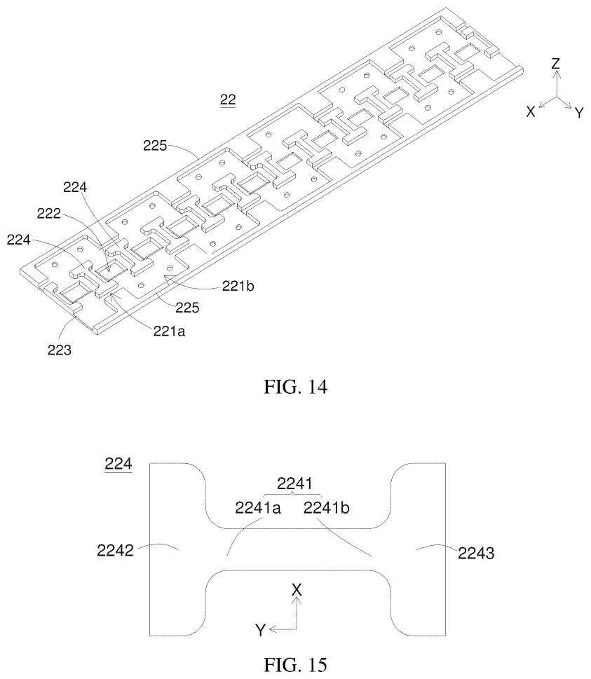

As shown in FIG. 14, in some embodiments, the wire harness separator 22 includes a substrate 223, a third protrusion portion 224, and a fourth protrusion portion 225, and both the third protrusion portion 224 and the fourth protrusion portion 225 are connected to the substrate 223 and protrude from the substrate 223. The substrate 223, the third protrusion portion 224, and the fourth protrusion portion 225 enclose to define the first recess 221a, and the substrate 223 and the fourth protrusion portion 225 enclose to define the second recess 221b.

The third protrusion portion 224 and the fourth protrusion portion 225 each protrude along a thickness direction Z of the substrate 223. Through such an arrangement, regardless of the arrangement of the third protrusion portion 224 and the fourth protrusion portion 225 relative to the substrate 223, at least part of a structure of the third protrusion portion 224 and at least part of a structure of the fourth protrusion portion 225 each can enhance the anti-bending strength of the substrate 223, to reduce a possibility of bending and deformation of the substrate 223 when being subjected to a larger external force and also reduce a possibility of bending and deformation of the electrical connector (not shown in FIG. 14) mounted at the wire harness separator 22, thereby reducing a possibility of a virtual electrical connection of the electrical connector with the cell (not shown in FIG. 14) and reducing a possibility of electric sparks generated by a connecting structure between the electrical connector and the cell. Therefore, according to the embodiments of the present disclosure, the arrangement of the structure of the wire harness separator 22 can improve operation reliability of the electrical connection between the electrical connector and the cell and improve safety of the battery pack.

The third protrusion portion 224, the fourth protrusion portion 225, and the substrate 223 enclose to define the first recess 221a configured to receive the wire harness (not shown in FIG. 14). The fourth protrusion portion 225 and the substrate 223 enclose to define the second recess 221b configured to receive the electrical connector (not shown in FIG. 14). The first recess 221a is in communication with the second recess 221b, to allow the wire harness to be connected to the electrical connector. That is, the third protrusion portion 224 and the fourth protrusion portion 225 in the embodiments of the present disclosure are not only configured to improve the anti-bending strength of the substrate 223, but also configured to serve as a structure for forming the first recess 221a. The fourth protrusion portion 225 in the embodiments of the present disclosure is not only configured to improve the anti-bending strength of the substrate 223, but also configured to serve as a structure for forming the second recess 221b. Therefore, the wire harness separator 22 in the embodiments of the present disclosure can realize two functions simultaneously by using a same structure. Compared with the wire harness separator in the related art that includes a structure for improving the anti-bending strength and a structure for defining a mounting groove respectively, the wire harness separator 22 in the embodiments of the present disclosure has a higher degree of structural compactness. The wire harness separator 22 with a higher degree of structural compactness occupies less space in the battery pack, so that the wire harness separator 22 can be provided with more electrical connectors, wire harnesses, and other parts in the battery pack.

In other embodiments, two fourth protrusion portions 225 and the substrate 223 may enclose to define the first recess 221a.

As shown in FIG. 14 and FIG. 15, in some embodiments, the third protrusion portion 224 includes a first section 2241, a second section 2242, and a third section 2243. The first section 2241 includes a first end 2241a and a second end 2241b arranged oppositely, the first end 2241a is connected to the second section 2242, the second end 2241b is connected to the third section 2243, the first section 2241 extends along a width direction Y of the substrate 223, and the second section 2242 and the third section 2243 each extend along a length direction X of the substrate 223. In other words, the third protrusion portion 224 may have an approximately “H”-shaped structure. With such an arrangement, the second section 2242 and the third section 2243 can improve the anti-bending strength of the substrate 223 to resist the bending moment M₁ about an axis O₁. The first section 2241 can improve the anti-bending strength of the substrate 223 to resist a bending moment M₂ about an axis O₂. Therefore, through the arrangement in the embodiments of the present disclosure, the operation reliability of the electrical connection between the electrical connector and the cell can be better improved, and the safety of the battery pack can be better improved.

The axis O₁ may be regarded as a center line of the second section 2242 and the third section 2243 along the direction Y, and the axis O₂ may be regarded as a center line of the first section 2241 along the direction X.

In other embodiments (not shown), the first section 2241 may be arranged along the length direction X of the substrate 223, and the second section 2242 and the third section 2243 each may be arranged along the width direction Y of the substrate 223.

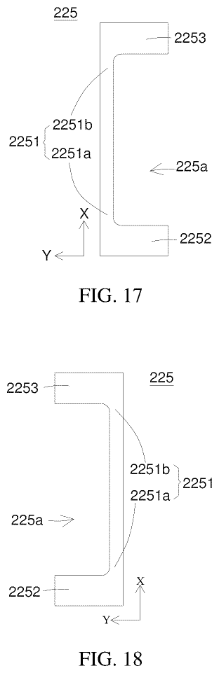

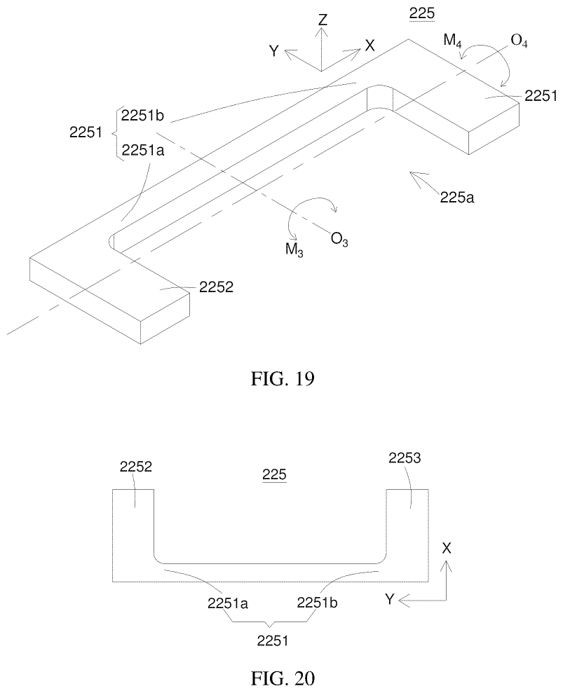

As shown in FIG. 17, FIG. 18, and FIG. 19, in some embodiments, the fourth protrusion portion 225 includes a fourth section 2251, a fifth section 2252, and a sixth section 2253. The fourth section 2251 includes a third end 2251a and a fourth end 2251b arranged oppositely. The third end 2251a is connected to the fifth section 2252, and the fourth end 2251b is connected to the sixth section 2253. The fourth section 2251 extends along the length direction X of the substrate 223, and the fifth section 2252 and the sixth section 2253 each extend along the width direction Y of the substrate 223. In other words, the fourth protrusion portion 225 may have an approximately “C”-shaped structure. With such an arrangement, the fifth section 2252 and the sixth section 2253 can improve the anti-bending strength of the substrate 223 to resist a bending moment M₄ about an axis O₄. The fourth section 2251 can improve the anti-bending strength of the substrate 223 to resist a bending moment M₃ about an axis O₃. Therefore, through the arrangement in the embodiments of the present disclosure, the operation reliability of the electrical connection between the electrical connector and the cell can be better improved, and the safety of the battery pack can be better improved.

The axis O₃ may be regarded as a center line of the fourth section 2251 along the direction Y, and the axis O₄ may be regarded as a center line of the fifth section 2252 and the sixth section 2253 along the direction X.

As shown in FIG. 20, in other embodiments (not shown), the fourth section 2251 may be arranged along the width direction Y of the substrate 223, and the fifth section 2252 and the sixth section 2253 each may be arranged along the length direction X of the substrate 223.

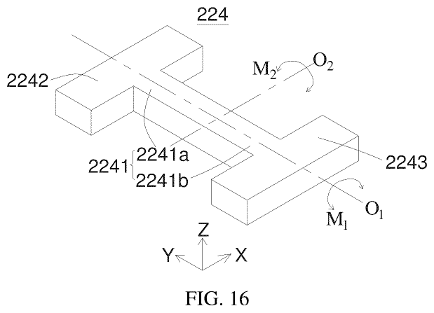

As shown in FIG. 14 to FIG. 17, in some embodiments, the second section 2242 and the substrate 223 may define the first recess 221a by cooperating with any structure in the fourth protrusion portion 225. For example, the second section 2242 and the substrate 223 may define the first recess 221a by cooperating with the fifth section 2252 or the sixth section 2253 of the fourth protrusion portion 225. The arrangement in the embodiments achieves the effect of a relatively higher degree of structural compactness of the wire harness separator 22. Details are not described herein again.

If the second section 2242 and the substrate 223 define the first recess 221a by cooperating with the fifth section 2252, a dimension of the second section 2242 along the direction X may be the same as or different from a dimension of the fifth section 2252 along the direction X. If the second section 2242 and the substrate 223 define the first recess 221a by operating with the sixth section 2253, the dimension of the second section 2242 along the direction X may be the same as or different from a dimension of the sixth section 2253 along the direction X.

In other embodiments (not shown), the second section 2242 and the substrate 223 define the first recess 221a by operating with the fourth section 2251 of the fourth protrusion portion 225.

Still referring to FIG. 14 to FIG. 17, in some embodiments, the third section 2243 and the substrate 223 may define the first recess 221a by cooperating with any structure in the fourth protrusion portion 225. For example, the third section 2243 and the substrate 223 may define the first recess 221a by operating with the fifth section 2252 or the sixth section 2253 of the fourth protrusion portion 225. The arrangement in the embodiments achieves the effect of a relatively higher degree of structural compactness of the wire harness separator 22. Details are not described herein again.

If the third section 2243 and the substrate 223 define the first recess 221a by operating with the fifth section 2252, a dimension of the third section 2243 along the direction X may be the same as or different from a dimension of the fifth section 2252 along the direction X. If the third section 2243 and the substrate 223 define the first recess 221a by operating with the sixth section 2253, the dimension of the third section 2243 along the direction X may be the same as or different from a dimension of the sixth section 2253 along the direction X.

In other embodiments (not shown), the third section 2243 and the substrate 223 may define the first recess 221a by operating with the fourth section 2251 of the fourth protrusion portion 225.

Since the wire harness separator 22 in the embodiments of the present disclosure may be provided with a plurality of first recesses 221a, the wire harness separator 22 may include any one of the above-mentioned structures for defining the first recess 221a.

In some embodiments, the second section 2242 is located between the first section 2241 and the second recess 221b.

Since the second recess 221b is configured to mount an electrical connector 2, part of the wire harnesses may extend from the first recess 221a into the second recess 221b and be connected to the corresponding electrical connector 2, but other wire harness of the wire harnesses may continuously extend along a direction parallel to the direction X. That is, the other wire harness may pass through a side of the second recess 221b and the electrical connector 2. The second section 2242 located between the first section 2241 and the second recess 221b can have a limiting effect on the other wire harness along the direction opposite to the direction Y, so that the other wire harness can be better placed on the wire harness separator 22 along the direction parallel to the direction X.

In some embodiments, the third section 2243 is located between the first section 2241 and the second recess 221b.

Since the second recess 221b is configured to mount an electrical connector 2, part of the wire harnesses may extend from the first recess 221a into the second recess 221b and be connected to the corresponding electrical connector 2, but other wire harness of the wire harnesses may continuously extend along a direction parallel to the direction X. That is, the other wire harness may pass through a side of the second recess 221b and the electrical connector 2. The third section 2243 located between the first section 2241 and the second recess 221b can have a limiting effect on the other wire harness along the direction Y, so that the other wire harness can be better placed on the wire harness separator 22 along the direction parallel to the direction X.

In some embodiments, at least two third protrusion portions 224 are arranged at intervals along the length direction X of the substrate 223, and an interval space may be formed between two third protrusion portions 224. The interval space may avoid other structure in the battery pack, so that the battery pack has a relatively higher degree of structural compactness, thereby reducing the volume of the battery pack. In addition, through the arrangement in the embodiments, at least two first recesses 221a distributed along the length direction X may also be formed, then the wire harness is arranged on the wire harness separator 22 along the length direction X. For example, as shown in FIG. 14, a plurality of third protrusion portions 224 are arranged at intervals along the length direction X of the substrate 223, and the communication portion 222 in communication with the explosion-proof valve of the cell is arranged between adjacent third protrusion portions 224.

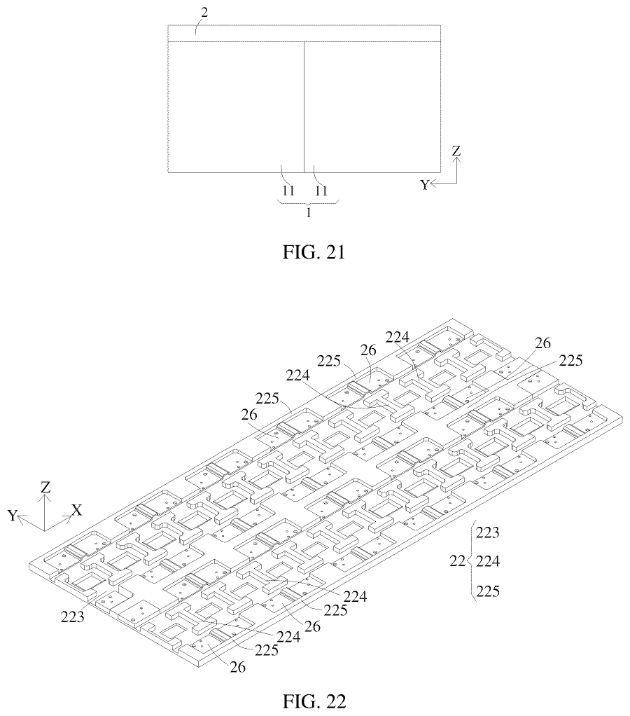

The cell assembly may include two rows of cells. For example, as shown in FIG. 21, the cell assembly 1 includes two columns of cells 11, and the two columns of cells 11 are arranged along a width direction Y of the CCS assembly 2. As described above, the number of the first channel(s) in the CCS assembly 2 may correspond to the number of row(s) of the cells. It can be understood that when the cell assembly includes two rows of cells, the CCS assembly may include two first channels, to spray the coolant to the corresponding cells.

As shown in FIG. 22 to FIG. 24, FIG. 22 to FIG. 24 show a CCS assembly applied to two rows of cells.

As shown in FIG. 22, the CCS assembly 10 may include a wire harness separator 22, a plurality of electrical connectors 26, a plurality of wire harnesses (not shown), and a plurality of temperature sensors (not shown).

The wire harness separator 22 includes two sides arranged oppositely along its own thickness direction (direction Z), one side is configured to mount the electrical connector 26, the wire harness, and the temperature sensor, and the other side is configured to mount the cell assembly 1 (as shown in FIG. 21), so that the wire harness and the cell assembly are separated by the wire harness separator 22.

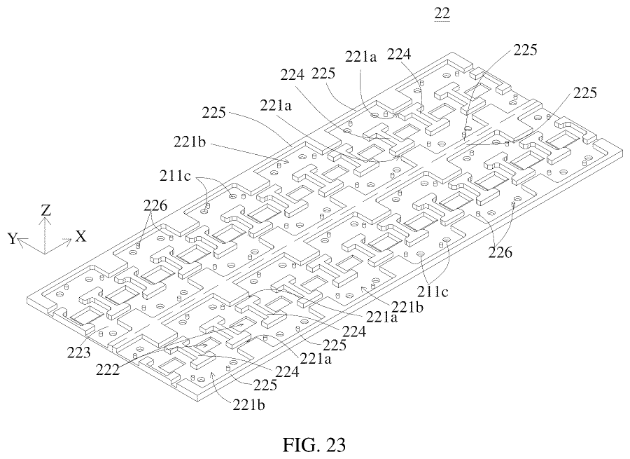

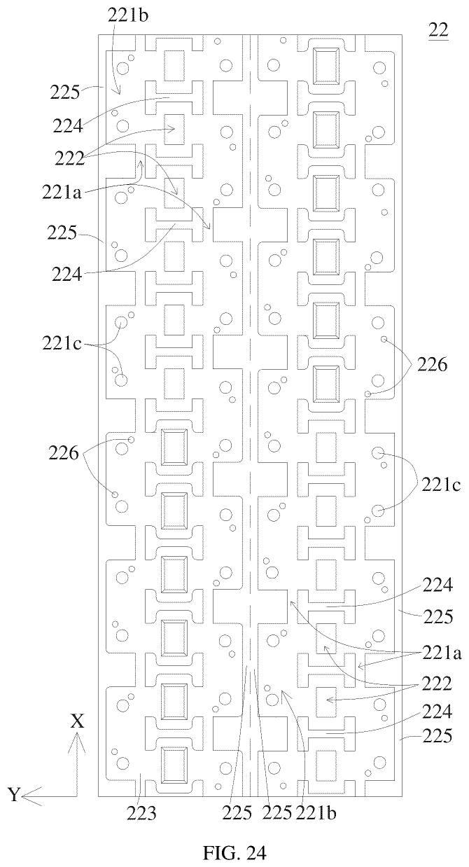

Referring to FIG. 22, FIG. 23, and FIG. 24 together, the wire harness separator 22 includes a substrate 223, a third protrusion portion 224, and a fourth protrusion portion 225. The third protrusion portion 224 and the fourth protrusion portion 225 each are connected to the substrate 223 and protrude from the substrate 223. The substrate 223, the third protrusion portion 224, and the fourth protrusion portion 225 enclose to define a first recess 221a, and the substrate 223 and the fourth protrusion portion 225 enclose to define a second recess 221b. The wire harness (not shown) is received in the first recess 221a, and the electrical connector 26 is received in the second recess 221b.

The wire harness separator 22 is provided with a fitting hole 221c, and an electrode structure (e.g., the pole 113 in FIG. 2) of each cell of the cell assembly may pass through the fitting hole 221c, so that the electrode structure can be connected (welded and electrically connected) to the electrical connector 26.

As described above, the communication portions at the wire harness separator are in one-to-one correspondence to the explosion-proof valves of the cells. As shown in FIG. 23, the substrate 223 may be provided with a plurality of communication portions 222. For example, along the length direction X of the substrate 223, a single communication portion 222 is arranged between every two third protrusion portions 224 arranged at intervals. For example, when the cell assembly 1 includes two rows of cells 11 (as shown in FIG. 21), the substrate 223 may be provided with at least two columns of communication portions 222 arranged at intervals along the width direction Y of the substrate 223. Each column of communication portions 222 includes at least two communication portions 222 arranged at intervals along the length direction X of the substrate 223.

As shown in FIG. 23, at least two fourth protrusion portions 225 are distributed along the length direction X of the substrate 223. This structure is configured to form the first recess 221a and the second recess 221b distributed along the length direction X, so that the wire harness (not shown) is arranged on the wire harness separator 22 along the length direction X and at least two electrical connectors 26 (as shown in FIG. 22) are distributed on the wire harness separator 22 along the length direction X.

In some embodiments, for every two adjacent fourth protrusion portions 225, the sixth section 2253 of one of the two adjacent fourth protrusion portions 225 is connected to the fifth section 2252 of the other one of the two adjacent fourth protrusion portions 225. This arrangement in the embodiments is more conducive to improving the anti-bending strength of the substrate 223.

In other embodiments (not shown), for every two adjacent fourth protrusion portions 225, the sixth section 2253 of one of the two adjacent fourth protrusion portions 225 and the fifth section 2252 of the other one of the two adjacent fourth protrusion portions 225 may be arranged at intervals.

As shown in FIG. 24, the wire harness separator 22 includes at least two columns of fourth protrusion portions 225 distributed along the width direction Y of the substrate 223. Each column of fourth protrusion portions 225 includes at least two fourth protrusion portions 225 distributed along the length direction X of the substrate 223. The arrangement in the embodiments is more conducive to improving the anti-bending strength of the substrate 223.

Referring to FIG. 17 and FIG. 18 together, in some embodiments, the fourth protrusion portion 225 defines an opening 225a, two columns of fourth protrusion portions 225 are arranged at intervals along the width direction Y of the substrate 223, and respective openings 225a are oriented opposite to each other. For example, one opening 225a is oriented in the direction Y, and the other one opening 225a is oriented in a direction opposite to the direction Y, and the two openings 225a are oriented towards each other.

In some other embodiments, the fourth protrusion portion 225 defines an opening 225a, two columns of fourth protrusion portions 225 are connected along the width direction Y of the substrate 223, and respective openings 225a are oriented in opposite directions. In detail, one opening 225a is oriented in the direction Y, the other opening 225a is oriented in a direction opposite to the direction Y, and the two openings 225a are oriented away from each other.

As shown in FIG. 23 and FIG. 24, the wire harness separator 22 further includes a connection pillar 226, the connection pillar 226 protrudes from a top surface of the substrate 223, at least part of a structure of the connection pillar 226 is located in the second recess 221b, and the connection pillar 226 is configured to be hot riveted with the electrical connector 26 (as shown in FIG. 22).

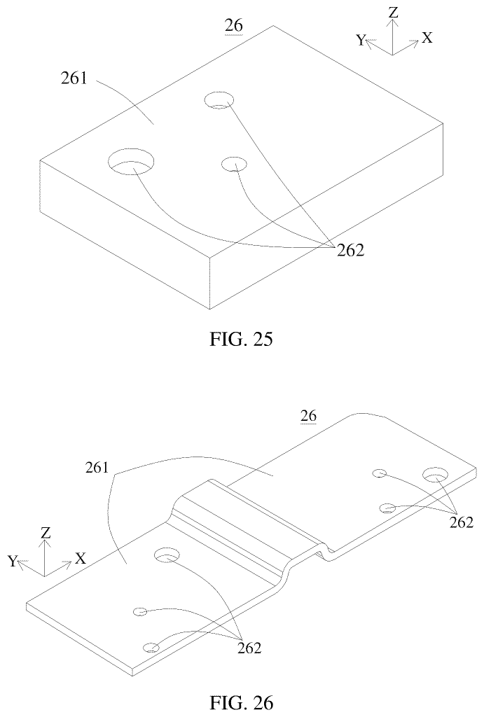

As shown in FIG. 25 and FIG. 26, the electrical connector 26 includes an electrical connection portion 261, and the electrical connection portion 261 is configured to be welded to the electrode structure (e.g., a positive electrode pole or a negative electrode pole) of the cell. For example, the cell may include a positive electrode pole and a negative electrode pole, the positive electrode pole may be connected to the electrical connection portion 261 of one electrical connector 26, and the negative electrode pole may be connected to the electrical connection portion 261 of another electrical connector 26.

As shown in FIG. 25, part of the electrical connectors 26 may include a single electrical connection portion 261, which may be configured to be connected to a positive electrode structure of the cell arranged first in an arrangement order along the direction X. As shown in FIG. 26, part of the electrical connectors 26 may include two electrical connection portions 261, one of the two electrical connection portions 261 is configured to be connected to a negative electrode structure of the cell arranged first in an arrangement order along the direction X, and the other one of the two electrical connection portions 261 is configured to be connected to a positive electrode structure of the cell arranged second in the arrangement order along the direction X. By analogy, the cells arranged along the direction X are electrically connected in series through a plurality of electrical connectors 26.

Still referring to FIG. 26, each electrical connection portion 261 of each electrical connector 26 is further provided with at least three connection holes 262. At least one connection hole 262 is penetrated through by the electrode structure of the cell 11 so that the electrical connection portion 261 is connected (welded and electrically connected) to the electrode structure of the cell 11; at least one connection hole 262 is penetrated through by the connection pillar 226 of the wire harness separator 22 so that the electrical connection portion 261 is connected (connected by interference fit or hot riveted) to the wire harness separator 22; and at least one connection hole 262 is penetrated through by the wire harness 25 so that the electrical connection portion 261 is connected to the wire harness 25, so that the wire harness 25 can collect current signals of the electrical connection portion 261.

The electrical connector 26 is made of aluminum, copper, or iron.

The wire harness separator 22 in the above embodiments may be integrally formed using an injection molding process.

In some embodiments of the present disclosure, the wire harness separator may also be formed by splicing a blister structural member and an injection molding structural member, which will be described in detail below with reference to the drawings.

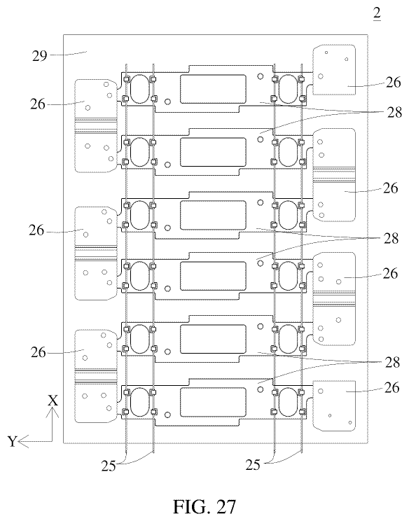

As shown in FIG. 27, the CCS assembly 2 may include injection molding structural members 28, a blister structural member 29, electrical connectors 26, wire harnesses 25, and temperature sensors (not shown). The molding structural members 28 are connected to the blister structural member 29. The electrical connectors 26 may be connected to the injection molding structural members 28 and the blister structural member 29, respectively. The wire harnesses 25 are connected to the injection molding structural members 28, and the wire harnesses 25 are further connected to the electrical connectors 26. A part of the wire harnesses 25 is directly connected to the electrical connectors 26 to collect current signals of the electrical connectors 26, and another part of the wire harnesses 25 is connected to the electrical connectors 26 through the temperature sensors to collect temperature signals of the electrical connectors 26.

For example, the CCS assembly 2 may include four sets of wire harnesses 25. The four sets of wire harnesses 25 are connected to a same column of injection molding structural members 28 arranged along the direction X. Two sets of wire harnesses 25 are connected to the electrical connectors 26 located at one side of the injection molding structural members 28, and the other two sets of wire harnesses 25 are connected to the electrical connectors 26 located on another one side of the injection molding structural members 28.

In the embodiments, it may be understood that the injection molding structural members 28 and the blister structural member 29 may be spliced into a wire harness separator.

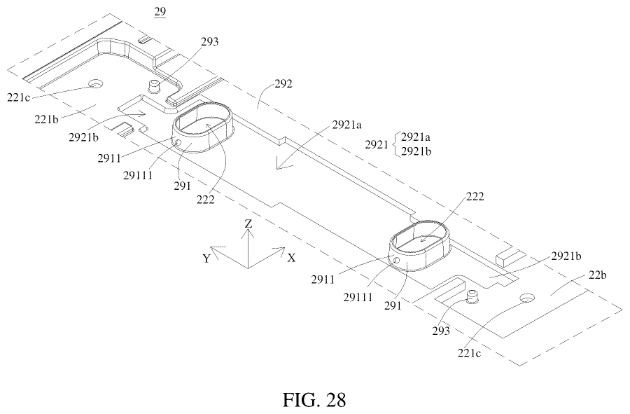

As shown in FIG. 28, the blister structural member 29 is provided with a fitting hole 221c. As described above, the electrode structure of each cell of the cell assembly may pass through the fitting hole 221c, so that the electrode structure can be connected (welded and electrically connected) to the electrical connector 26 in FIG. 27.

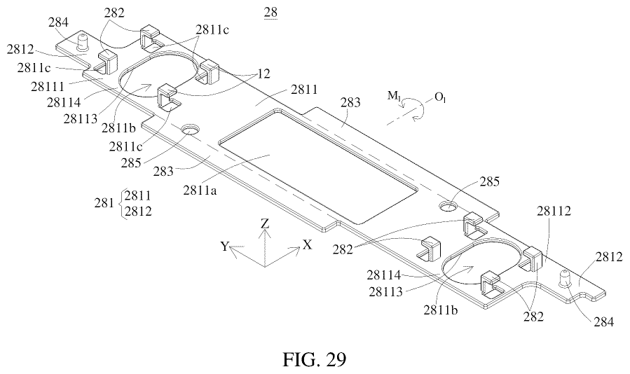

As shown in FIG. 25 and FIG. 26, as mentioned above, each electrical connection portion 261 of each electrical connector 26 is further provided with at least three connection holes 262. At least one connection hole 262 is penetrated through by the electrode structure of the cell so that the electrical connection portion 261 is connected (welded and electrically connected) to the electrode structure of the cell; referring to FIG. 29 together, at least one connection hole 262 is penetrated through by a connecting structure 284 of the injection molding structural member 28 so that the electrical connection portion 261 is connected (connected by interference fit or hot riveted) to the injection molding structural member 28; and referring to FIG. 28 together, at least one connection hole 262 is penetrated through by a first limiting pillar 293 of the blister structural member 29 so that the electrical connection portion 261 is positioned relative to the blister structural member 29.

The blister structural member 29 serves as a main mounting structure of the CCS assembly 2. The blister structural member 29 is less prone to warping and deformation. The injection molding structural member 28 serves as an auxiliary mounting structure of the CCS assembly 2. The structural stiffness of the injection molding structural member 28 is greater than that of the blister structural member 29. A connecting structure of the injection molding structural member 28 and the blister structural member 29 can further reduce the possibility of warping and deformation of the blister structural member 29. With such an arrangement, the electrical connector 26 mounted on the blister structural member 29 is less prone to bending and deformation, and a virtual electrical connection between the electrical connector 26 and the cell 11 is less prone to occur. Correspondingly, a connecting structure between the electrical connector 26 and the cell is less prone to electric sparks. Therefore, the electrical connection between the electrical connector 26 and the cell has a higher degree of operation reliability, and the battery pack has a higher degree of safety.

Still referring to FIG. 27, in some embodiments, the CCS assembly 2 may include at least two injection molding structural members 28 arranged at intervals along a length direction X of the wire harness 25. With such an arrangement, the blister structural member 29 is further less prone to warping and deformation. Then, more structures are used to connect the wire harness 25, and the wire harness 25 can be better arranged along the direction X.

As shown in FIG. 29, in some embodiments, the injection molding structural member 28 includes a first main body 281 and a clamping portion 282 connected to each other. Referring to FIG. 27 and FIG. 28 together, the first main body 281 is connected to the blister structural member 29, and the clamping portion 282 is clamped to the wire harness 25. With such an arrangement, on the one hand, a user can remove part of the wire harnesses 25 from the injection molding structural member 28 or mount part of the wire harnesses 25 on the injection molding structural member 28 during maintenance, so the user has less maintenance workload. On the other hand, the clamping portion 282 is clamped to the wire harness 25 so that corresponding disassembly and mounting difficulty is lower.

A same injection molding structural member 28 includes four sets of clamping portions 282. Each set of clamping portions 282 include two clamping portions 282. The four sets of clamping portions 282 are arranged at intervals along the direction Y. The two clamping portions 282 in a same set of clamping portions 282 are arranged at intervals along the direction X. In a same set of clamping portions 282, one clamping portion 282 limits movement of the wire harness 25 in the direction Y, and the other one clamping portion 282 limits movement of the wire harness 25 in the direction opposite to the direction Y.

In addition, a structure of the clamping portion 282 may be L-shaped, C-shaped or U-shaped. The first main body 281 is provided with a second through-hole 2811c corresponding to the clamping portion 282, so that the clamping portion 282 in the above-mentioned shape can be formed by an injection molding process. In addition, due to the arrangement of the second through-hole 2811c, the injection molding structural member 28 and the CCS assembly 2 have smaller weights. The CCS assembly 2 exerts less weight load on the cell assembly 1, thus the cell assembly 1 is less likely to be crushed by the CCS assembly 2. Moreover, the battery pack has a smaller weight, and the battery pack is more easily carried, mounted, and disassembled by the user.

Referring to FIG. 28 and FIG. 29 together, in some embodiments, the injection molding structural member 28 further includes a reinforcing portion 283. The reinforcing portion 283 is connected to the first main body 281 and the blister structural member 29, respectively; and the reinforcing portion 283 extends along a direction Y perpendicular to the length direction X of the wire harness 25. That is, the reinforcing portion 283 is arranged along the direction Y. With such an arrangement, the injection molding structural member 28 has better anti-bending strength to resist a bending moment M₁ about an axis O₁. Correspondingly, the blister structural member 29 connected to the injection molding structural member 28 also has better anti-bending strength, that is, the blister structural member 29 is less prone to bending and deformation about the axis O₁, and a virtual electrical connection between the electrical connector 26 and the cell 11 is less prone to occur.

In some embodiments, the reinforcing portion 283 is arranged at each of two opposite sides of the first main body 281 along the length direction X of the wire harness 25. With such an arrangement, the injection molding structural member 28 has greater anti-bending strength.

In some embodiments, the reinforcing portion 283 located at one side of the first main body 281 and the reinforcing portion 283 located at the other side of the first main body 281 are misaligned along the direction Y. With such an arrangement, the length of the reinforcing portion 283 at either side may be relatively short, which can not only improve the anti-bending strength of the injection molding structural member 28, but also avoid necessary structures in the blister structural member 29 and the electrical connector 26, so that the CCS assembly 2 has a higher degree of structural compactness, the CCS assembly 2 occupies less space in the battery pack, and the cell assembly 1 has a relatively larger size, thereby allowing the battery pack to store more electrical energy.

Still referring to FIG. 29, in some embodiments, the first main body 281 is provided with a first through-hole 2811a, and the first through-hole 2811a is positioned between the reinforcing portion 283 located at one side of the first main body 281 and the reinforcing portion 283 located at the other side of the first main body 281. With such an arrangement, the injection molding structural member 28 and the CCS assembly 2 have smaller weights. The CCS assembly 2 exerts less weight load on the cell assembly 1, thus the cell assembly 1 is less likely to be crushed by the CCS assembly 2. Moreover, the battery pack has a smaller weight, and the battery pack is more easily carried, mounted, and disassembled by the user.

In some embodiments, the first through-hole 2811a is in a shape of a rectangle or in a shape of a rectangle with rounded corners. The arrangement of the shape of the rectangle with rounded corners reduces stress concentration at a side wall of the first main body 281 for defining the first through-hole 2811a, thus the structure of the first main body 281 is less likely to have structural problems such as cracking or breakage.

Referring to FIG. 27 to FIG. 29 together, in some embodiments, a third through-hole 285 is provided at a junction between the first main body 281 and the reinforcing portion 283, and part of the structure of the blister structural member 29 (e.g., a second limiting pillar (not shown) protruding along the direction Z) passes through the third through-hole 285, so that the injection molding structural member 28 is positioned relative to the blister structural member 29. With such an arrangement, the injection molding structural member 28 is not easy to move arbitrarily relative to the blister structural member 29, and the electrical connector 26 and the wire harness 25 connected to the injection molding structural member 28 are relatively fixed relative to the blister structural member 29. That is, the CCS assembly 2 has a higher degree of operation reliability.

Still referring to FIG. 29, in some embodiments, a thickness of the reinforcing portion 283 (a dimension along the direction Z) is greater than or equal to that of the first main body 281 (a dimension along the direction Z).

If the thickness of the reinforcing portion 283 (the dimension along the direction Z) is greater than that of the first main body 281 (the dimension along the direction Z), the injection molding structural member 28 has greater anti-bending strength. A ratio of the thickness of the reinforcing portion 283 (the dimension along the direction Z) to the thickness of the first main body 281 (the dimension along the direction Z) ranges from 1.1 to 2. The ratio may be, for example, 1.1, 1.2, 1.3, 1.4, 1.5, 1.6, 1.7, 1.8, 1.9, or 2.0.

Referring to FIG. 27 and FIG. 29 together, in some embodiments, the first main body 281 includes a first plate body 2811 and two second plate bodies 2812. The first plate body 2811 is connected to the clamping portion 282, and the second plate body 2812 is directly or indirectly connected to the electrical connector 26. The first plate body 2811 includes a left end portion 28111 and a right end portion 28112 arranged opposite to each other along a direction (direction Y) perpendicular to the length direction (direction X) of the wire harness 25. In other words, the left end portion 28111 and the right end portion 28112 are arranged opposite to each other along the direction Y, and the left end portion 28111 and the right end portion 28112 are connected to corresponding second plate bodies 2812. Correspondingly, the electrical connector 26 is arranged at each of two sides of the first main body 281 in the direction Y. Thus, it can be inferred that a same injection molding structural member 28 may be simultaneously connected to two electrical connectors 26 arranged oppositely along the direction Y, and the structure of the injection molding structural member 28 extends along the direction Y. With such an arrangement, the injection molding structural member 28 has better anti-bending strength to resist the bending moment M₁ about the axis O₁. Correspondingly, the blister structural member 29 connected to the injection molding structural member 28 also has better anti-bending strength, that is, the blister structural member 29 is less prone to bending and deformation about the axis O₁, and a virtual electrical connection between the electrical connector 26 and the cell is less prone to occur.

The axis O₁ may be regarded as a center line of the first plate body 2811 along the direction X.

In some embodiments, the second plate body 2812 connected to the left end portion 28111 and the second plate body 2812 connected to the right end portion 28112 are misaligned in the length direction X of the wire harness 25. With such an arrangement, the injection molding structural member 28 has a structure that is not symmetrical with respect to the axis O₁, that is, the injection molding structural member 28 has a fool-proof function in terms of mounting, which reduces a possibility of incorrect mounting of the injection molding structural member 28 on the blister structural member 29, thereby improving operation reliability of the CCS assembly 2 and the battery pack 10.

In some embodiments, in a same first main body 281, one second plate body 2812 has a different shape than the other second plate body 2812. With such an arrangement, the injection molding structural member 28 has a structure that is more obviously not symmetrical with respect to the axis O₁, and the injection molding structural member 28 has a better fool-proof function in terms of mounting, so that there is a lower possibility that the injection molding structural member 28 is incorrectly mounted on the blister structural member 29, thus the CCS assembly 2 and the battery pack 10 have a higher degree of operation reliability.

In a same first main body 281, one second plate body 2812 may be in a shape of a rectangle, and the other second plate body 2812 may be in a shape of a stair. Certainly, the second plate body 2812 may be in other shapes.

Referring to FIG. 27 and FIG. 29 together, at least part of the structure of the electrical connector 26 is located between the second plate body 2812 and the blister structural member 29. With such an arrangement, movement of the electrical connector 26 along the direction parallel to the direction Z is limited by the second plate body 2812 and the blister structural member 29, and the connecting structure between the electrical connector 26 and the cell 11 has a higher degree of reliability.

In some embodiments, at least part of the structure of the electrical connector 26 abuts against a surface of the second plate body 2812 facing away from the blister structural member 29. With such an arrangement, movement of the injection molding structural member 28 along the direction parallel to the direction Z is limited by the electrical connector 26 and the blister structural member 29, and the injection molding structural member 28 can limit the wire harness 25 more reliably, thereby improving reliability of the connecting structure between the wire harness 25 and the electrical connector 26.

In some embodiments, stiffness of the second plate body 2812 is greater than that of the first plate body 2811, and a ratio of the stiffness of the second plate body 2812 to the stiffness of the first plate body 2811 ranges from 1.1 to 2.5. The ratio may be, for example, 1.1, 1.2, 1.3, 1.4, 1.5, 1.6, 1.7, 1.9, 2.0, 2.1, 2.2, 2.3, 2.4, or 2.5. With such an arrangement, a connecting structure between the second plate body 2812 and the electrical connector 26 has better operation reliability.

The stiffness is used to represent a capability to resist deformation.

In some embodiments, strength of the second plate body 2812 is greater than that of the first plate body 2811, and a ratio of the strength of the second plate body 2812 to the strength of the first plate body 2811 ranges from 1.1 to 2. The ratio may be, for example, 1.1, 1.2, 1.3, 1.4, 1.5, 1.6, 1.7, 1.9, 2.0, 2.1, 2.2, 2.3, 2.4, or 2.5. With such an arrangement, a connecting structure between the second plate body 2812 and the electrical connector 26 has better operation reliability.

The strength is used to represent a capability to resist breakage.

In some embodiments, a thickness of the first plate body 2811 and a thickness of the second plate body 2812 are different.

If the thickness of the first plate body 2811 is greater than the thickness of the second plate body 2812, the second plate body 2812 may avoid a part of structure members of the battery pack in the direction Z. Correspondingly, a ratio of the thickness of the first plate body 2811 to the thickness of the second plate body 2812 ranges from 1.1 to 2. The ratio may be, for example, 1.1, 1.2, 1.3, 1.4, 1.5, 1.6, 1.7, 1.9, 2.0, 2.1, 2.2, 2.3, 2.4, or 2.5.

If the thickness of the second plate body 2812 is greater than the thickness of the first plate body 2811, the first plate body 2811 may avoid another part of structure members of the battery pack in the direction Z. Correspondingly, a ratio of the thickness of the second plate body 2812 to the thickness of the first plate body 2811 ranges from 1.1 to 2. The ratio may be, for example, 1.1, 1.2, 1.3, 1.4, 1.5, 1.6, 1.7, 1.9, 2.0, 2.1, 2.2, 2.3, 2.4, or 2.5.

Still referring to FIG. 29, in some embodiments, the injection molding structural member 28 further includes a connecting structure 284 protruding from the second plate body 2812, and as described above, the connecting structure 284 passes the connection hole 262 (as shown in FIG. 26) of the electrical connector 26 so that the connecting structure 284 is riveted with the electrical connector 26. For example, the connecting structure 284 is hot riveted with the electrical connector 26.

In other embodiments (not shown), the second plate body 2812 may be directly connected to (e.g., clamped or bonded to) the electrical connector 26.

As shown in FIG. 28 and FIG. 29, in some embodiments, the blister structural member 29 includes a protrusion structure 291, the injection molding structural member 28 is provided with a first mounting hole 2811b, the protrusion structure 291 passes the first mounting hole 2811b. An inner side wall 28113 of the injection molding structural member 28 for defining the first mounting hole 2811b is bonded or clamped to an outer side wall 2911 of the protrusion structure 291. With such an arrangement, the connection between the blister structural member 29 and the injection molding structural member 28 has a higher degree of reliability.

The first mounting hole 2811b is arranged at the first main body 281 of the injection molding structural member 28.

In addition, the clamping portion 282 is arranged at each of two sides of the first mounting hole 2811b along the direction Y.

Moreover, the blister structural member 29 may include at least two pairs of protrusion structures 291, the at least two pairs of protrusion structures 291 are arranged at intervals along the direction X, and two protrusion structures 291 in each pair of protrusion structures 291 are arranged at intervals along the direction Y. Correspondingly, each injection molding structural member 28 is provided with two first mounting holes 2811b arranged at intervals along the direction Y, and each pair of protrusion structures 291 is connected to a same injection molding structural member 28.

In addition, the clamping between the inner side wall 28113 and the outer side wall 2911 may include a structural limiting connection or an interference fit connection.

Still referring to FIG. 28 and FIG. 29, in some embodiments, the inner side wall 28113 of the injection molding structural member 28 for defining the first mounting hole 2811b is in a shape of a track, and the outer side wall 2911 of the protrusion structure 291 is in a shape of a track. With such an arrangement, the injection molding structural member 28 is less prone to rotation around an axis parallel to the direction Z relative to the blister structural member 29.

In some embodiments, the outer side wall 2911 of the protrusion structure 291 further includes at least two symmetrically arranged limiting portions 29111. The limiting portion 29111 abuts against a top surface 28114 of the injection molding structural member 28 to prevent the protrusion structure 291 from being detached from the first mounting hole 2811b. According to the arrangement in the embodiments, the reliability of the connecting structure between the injection molding structural member 28 and the blister structural member 29 can be further improved.

A same protrusion structure 291 may include two limiting portions 29111 arranged oppositely along the direction X, or a same protrusion structure 291 may include two limiting portions 29111 arranged oppositely along the direction Y.

In other embodiments, a same protrusion structure 291 may include two limiting portions 29111 arranged oppositely along the direction X, and the same protrusion structure 291 may also include two limiting portions 29111 arranged oppositely along the direction Y.

In some embodiments, the limiting portion 29111 is formed as a recessed structure or a protrusion structure. These two structures can satisfy the arrangement of “the limiting portion 29111 abutting against a top surface 28114 of the injection molding structural member 28”.

In some embodiments, if the limiting portion 29111 is formed as a protrusion structure, the surface of the limiting portion 29111 is in a shape of a hemispherical surface. With such an arrangement, when the user assembles the injection molding structural member 28 and the blister structural member 29, the inner side wall 28113 of the injection molding structural member 28 for defining the first mounting hole 2811b and the limiting portion 29111 can slide relatively smoothly relative to each other, thereby facilitating the user to assemble the injection molding structural member 28 and the blister structural member 29 more smoothly. Similarly, with such an arrangement, when the user disassembles the injection molding structural member 28 and the blister structural member 29, the inner side wall 28113 of the injection molding structural member 28 for defining the first mounting hole 111b and the limiting portion 29111 can slide relatively smoothly relative to each other, thereby facilitating the user to disassemble the injection molding structural member 28 and the blister structural member 29 more smoothly.

In some embodiments, an area of a cross section of the protrusion structure 291 in a direction perpendicular to a protruding direction (direction Z) of the protrusion structure 291 gradually decreases along the protruding direction (direction Z). With such an arrangement, the outer side wall 2911 of the protrusion structure 291 serves as a guide slope, and when the inner side wall 28113 of the injection molding structural member 28 for defining the first mounting hole 2811b abuts against the outer side wall 2911 of the protrusion structure 291, the outer side wall 2911 of the protrusion structure 291 can guide the injection molding structural member 28 to approach the blister structural member 29 to a correct mounting position.

As shown in FIG. 28, in some embodiments, the protrusion structure 291 is provided with a communication portion 222 arranged along the protruding direction (direction Z) of the protrusion structure 291. The communication portion 222 may serve as a pressure relief hole. The communication portion 222 is used for electrolyte of the cell 11 in a thermal runaway state to pass through, so as to reduce a possibility of explosion inside the cell 11 due to incapability to release the electrolyte quickly.

Referring to FIG. 28 and FIG. 29 together, in some embodiments, the blister structural member 29 includes a second main body 292, the second main body 292 is provided with an accommodation space 2921, and part of a structure of the injection molding structural member 28 is mounted in the accommodation space 2921. With such an arrangement, an assembly structure of the blister structural member 29 and the injection molding structural member 28 is relatively compact, a dimension of the CCS assembly in the direction Z is smaller, and the CCS assembly occupies less space in the battery pack. Correspondingly, a volume of the cell assembly can be designed to be larger, and the cell assembly can store more electrical energy.

The accommodation space 2921 includes a first accommodation portion 2921a and a second accommodation portion 2921b, the first accommodation portion 2921a is configured to mount the first plate body 2811, and the second accommodation portion 2921b is configured to mount part of the structure of the second plate body 2812.

In addition, a same accommodation space 2921 may include two second accommodation portions 2921b. For example, the second accommodation portion 2921b is arranged at each of two sides of the first accommodation portion 2921a along the direction (direction Y) perpendicular to the length direction (direction X) of the wire harness 25. The second accommodation portion 2921b located at one side of the first accommodation portion 2921a and the second accommodation portion 2921b located at the other side of the first accommodation portion 2921a are misaligned along the length direction (direction X) of the wire harness 25. A shape of one second accommodation portion 2921b matches the shape of the second plate body 2812 connected to the left end portion 28111, and a shape of the other second accommodation portion 2921b matches the shape of the second plate body 2812 connected to the right end portion 28112, that is, the accommodation space 2921 has a better fool-proof function in terms of mounting, thereby reducing a possibility of incorrect mounting of the injection molding structural member 28 on the blister structural member 1, and improving operation reliability of the CCS assembly 2 and the battery pack 10.

In some embodiments, an inner surface of the accommodation space 2921 is bonded or clamped to the injection molding structural member 28.

Referring to FIG. 27 and FIG. 28 together, in some embodiments, the second main body 292 is further provided with a second recess 221b, at least part of the structure of the electrical connector 26 is mounted in the second recess 221b, a space defined by the second recess 221b is in communication with a space defined by the accommodation space 2921, and another part of the structure of the injection molding structural member 28 is located in the second recess 221b, so that the structure of the injection molding structural member 28 located in the second recess 221b is directly or indirectly connected to the electrical connector 26.

Referring to FIG. 29 together, the second plate body 2812 of the injection molding structural member 28 extends from the second accommodation portion 2921b of the accommodation space 2921 to the second recess 221b.

In some embodiments, the blister structural member is located between the injection molding structural member 28 and the cell assembly 1. Correspondingly, the electrical connector 26 is located at a side of the blister structural member 29 facing away from the cell assembly 1, so as to meet a requirement that the injection molding structural member 28, and the wire harness 25 and the electrical connector 26 that are connected to the injection molding structural member 28 avoid the cell assembly 1.

In other embodiments, at least part of the structure of the injection molding structural member 28 may be located at a side of the blister structural member 29 facing the cell assembly 1. For example, the first main body 281 is located at a side of the blister structural member 29 facing the cell assembly 1, and the clamping portion 282 is located at a side of the first main body 281 facing away from the cell assembly 1, or the clamping portion 282 is located at a side of the first main body 281 facing the cell assembly 1. Further, the clamping portion 282 may be located between the first main body 281 and the blister structural member 29, and the electrical connector 26 and the wire harness 25 are both located at a side of the blister structural member 29 facing the cell assembly 1. With such an arrangement, the blister structural member 29 is not required to be provided with a fitting hole 221c for the electrode structure of the cell assembly 1 to pass through, and it is simpler and easier to manufacture the structure of the blister structural member 29. In addition, the electrical connector 26 is closer to the main structure of the cell assembly 1, a dimension of the electrode structure of the cell 11 of the cell assembly 1 along the direction Z is shorter, the saved space allows the volume of the main structure of the cell 11 to be larger, and the cell 11 can store more electrical energy. Alternatively, the clamping portion 282 may pass through the blister structural member 29, so that part of the structure of the clamping portion 282 is located at a side of the blister structural member 29 facing away from the cell assembly 1, and the electrical connector 26 and the wire harness 25 are both located at a side of the blister structural member 29 facing away from the cell assembly 1. This arrangement facilitates the user to replace the electrical connector 26 and the wire harness 25.

In some embodiments, a surface of the first main body 281 facing the cell assembly 1 (a bottom surface of the first main body 281) is flush with a surface of the blister structural member 29 facing the cell assembly 1 (a bottom surface of the blister structural member 29).

In some embodiments, the surface of the first main body 281 facing the cell assembly 1 (the bottom surface of the first main body 281) is closer to the cell assembly 1 than the surface of the blister structural member 29 facing the cell assembly 1 (the bottom surface of the blister structural member 29). With such an arrangement, the blister structural member 29 can avoid part of the structure of the cell assembly 1.

In some embodiments, the surface of the blister structural member 29 facing the cell assembly 1 (the bottom surface of the blister structural member 29) is closer to the cell assembly 1 than the surface of the first main body 281 facing the cell assembly 1 (the bottom surface of the first main body 281). With such an arrangement, the first main body 281 can avoid part of the structure of the cell assembly 1.

Based on the CCS assembly in the above-described embodiments, a method for forming a battery pack includes the following steps.
At step S1, all injection molding structural members are simultaneously assembled to the blister structural member.
At step S2, all electrical connectors are simultaneously assembled to the blister structural member.
At step S3, wire harnesses are assembled to the injection molding structural members.
At step S4, all injection molding structural members and corresponding electrical connectors are simultaneously hot riveted.
At step S5, all electrical connectors and corresponding wire harnesses are simultaneously welded by laser welding or ultrasonic welding.
At step S6, all electrical connectors and corresponding temperature sensors are simultaneously welded by laser welding or ultrasonic welding.

The method provided in the embodiments of the present disclosure has a high efficiency, and more battery packs can be formed per unit time.

In some embodiments, the order of step S1 and step S2 is not limited in the embodiments of the present disclosure. Step S1 may be completed first, followed by step S2, or step S2 may be completed first, followed by step S1, or step S1 and step S2 may be completed at the same time.

In some embodiments, the order of step S3 and step S4 is not limited in the embodiments of the present disclosure. Step S3 may be completed first, followed by step S4, or step S4 may be completed first, followed by step S3. In addition, step S3 and step S4 may be completed after completion of step S1 and step S2.

In some embodiments, the order of step S5 and step S6 is not limited in the embodiments of the present disclosure. Step S5 may be completed first, followed by step S6, or step S6 may be completed first, followed by step S5. In addition, step S5 and step S6 may be completed after completion of step S3 and step S4.

The CCS assembly in the above-described embodiments may be provided with a first channel configured to spray coolant. For example, the CCS assembly may include a cover body, the cover body may be connected to a blister structural member and/or an injection molding structural member, and the first channel is arranged in the cover body. As described above, the protrusion structure of the blister structural member is provided with a communication portion, and the communication portion may serve as a pressure relief hole to allow the electrolyte of the cell in a thermal runaway state to pass through. It can be understood that when the temperature of the cell exceeds the normal value, the cell begins to release pressure to the outside through the explosion-proof valve, and at the same time ejects high-temperature heat flow. In this case, the coolant from the first channel is sprayed to the explosion-proof valve of the cell to cool down the cell, thereby reducing a possibility of thermal runaway of the entire cell assembly due to heat diffusion and reducing a risk of combustion and explosion of the cell assembly, which helps improve safety of the battery pack.

The above-described embodiments are merely preferred embodiments of the present disclosure and are not intended to limit the present disclosure. Any modifications, equivalent substitutions and improvements made within the principle of the present disclosure shall fall into the protection scope of the present disclosure.

What is claimed is:

1. A battery pack, comprising:
a cell assembly, wherein the cell assembly comprises a plurality of cells, and each of the plurality of cells is electrically connected through an electrical connector; and
a cells contact system (CCS) assembly, wherein the CCS assembly is located at a side of the cell assembly and is electrically connected to the electrical connector through a wire harness, the CCS assembly comprises a first channel, and a position where the first channel is positioned corresponds to positions where explosion-proof valves of the plurality of cells are positioned, such that liquid is sprayed to the explosion-proof valves,
wherein the CCS assembly comprises a wire harness separator, the wire harness separator comprises a first accommodation groove, in which the wire harness and the electrical connector are received.

2. The battery pack according to claim 1,
wherein the first channel comprises a plurality of spray portions facing the plurality of cells, and
wherein the plurality of spray portions are positioned in one-to-one correspondence to the explosion-proof valves of the cells, and the first channel sprays the liquid correspondingly to the explosion-proof valves through the plurality of spray portions.

3. The battery pack according to claim 2,
wherein the first channel comprises a through-channel bottom wall, and
wherein the plurality of spray portions are located at the through-channel bottom wall, and a thickness of each of the plurality of spray portions is less than a thickness of the through-channel bottom wall.

4. The battery pack according to claim 2,
wherein the first channel comprises a through-channel bottom wall, and the plurality of spray portions are valve bodies arranged at the through-channel bottom wall.

5. The battery pack according to claim 2, wherein a reinforcing structure is provided between two adjacent spray portions of the plurality of spray portions.

6. The battery pack according to claim 2, wherein a second channel is provided between each of the plurality of spray portions and an explosion-proof valve of the explosion-proof valves corresponding thereto.

7. The battery pack according to claim 6,
wherein the cell comprises a top cover, and
wherein:
the explosion-proof valve is arranged at the top cover, and the top cover comprises a first protrusion portion extending towards the CCS assembly; and/or
the CCS assembly comprises a second protrusion portion extending towards the cell, and the first protrusion portion and/or the second protrusion portion defines the second channel.

8. The battery pack according to claim 2,
wherein the CCS assembly comprises a cover body, and the cover body is located at a side of the wire harness separator away from the cell assembly and is detachably connected to the wire harness separator.

9. The battery pack according to claim 8, wherein the first channel is arranged at the cover body, the wire harness separator is provided with a communication portion, and the communication portion, a spray portion of the spray portions, and an explosion-proof valve of the explosion-proof valves are positioned corresponding to one another.

10. The battery pack according to claim 9, wherein the cover body and the wire harness separator enclose to define a first region and a second region, the first accommodation groove is arranged in the first region and the communication portion is arranged in the second region, and an isolation member is provided between the first region and the second region to isolate the first region from the second region.

11. The battery pack according to claim 10, wherein the isolation member is a sealing strip, the sealing strip is arranged around a circumference of the second region, and the isolation member comprises an end abutting against the wire harness separator and another end abutting against the cover body.

12. The battery pack according to claim 10, wherein the isolation member is a baffle, the baffle is arranged around a circumference of the second region, and the baffle is integrally formed with the wire harness separator and abuts against the cover body.

13. The battery pack according to claim 8, wherein the first channel is arranged between the wire harness separator and the cover body.

14. The battery pack according to claim 8, wherein the cover body is provided with a second accommodation groove, the second accommodation groove is in communication with the first accommodation groove, and the wire harness and the electrical connector are received between the first accommodation groove and the second accommodation groove.

15. The battery pack according to claim 8, wherein the cover body and/or the wire harness separator is an injection molding member.

16. The battery pack according to claim 1,
wherein the wire harness separator comprises a substrate and a third protrusion portion and a fourth protrusion portion that are connected to the substrate,
wherein the first accommodation groove comprises a first recess and a second recess in communication with the first recess; the substrate, the third protrusion portion, and the fourth protrusion portion enclose to define the first recess; and the substrate and the fourth protrusion portion enclose to define the second recess, and
wherein the wire harness is received in the first recess, and the electrical connector is received in the second recess.

17. The battery pack according to claim 16, wherein along a thickness direction of the wire harness separator, a cross section of the first recess is U-shaped or V-shaped.

18. The battery pack according to claim 16,
wherein the third protrusion portion comprises a first section and a second section and a third section that are respectively connected to two sides of the first section, and
wherein the first section extends along a width direction of the substrate, and the second section and the third section each extend along a length direction of the substrate.

19. The battery pack according to claim 16, wherein a plurality of third protrusion portions are arranged at intervals along a length direction of the wire harness separator, and a communication portion in communication with an explosion-proof valve of the explosion-proof valves of the cells is arranged between adjacent third protrusion portions of the plurality of third protrusion portions.

20. The battery pack according to claim 16,
wherein the fourth protrusion portion comprises a fourth section and a fifth section and a sixth section that are respectively connected to two sides of the fourth section, and
wherein the fourth section extends along a length direction of the substrate, and the fifth section and the sixth section each extend along a width direction of the substrate.
